(19) United States
(12) Patent Application Publication
(10) Pub. No.: US 2013/0055112 A1
(43) Pub. Date: Feb. 28, 2013

(54) Computerized System And Method Supporting Message-Based Group Communication Sessions

(71) Applicants: Arnon Joseph, Herzlelia (IL); Omry Levy, Kiryat Ono (IL); Ehud Zohar, Tel Aviv (IL)

(72) Inventors: Arnon Joseph, Herzlelia (IL); Omry Levy, Kiryat Ono (IL); Ehud Zohar, Tel Aviv (IL)

(73) Assignee: HOOZIN LTD., Tel Aviv (IL)

(21) Appl. No.: 13/414,255

(22) Filed: Mar. 7, 2012

(30) Foreign Application Priority Data
Aug. 28, 2011 (IL) 214855

(51) Int. Cl. G06F 3/01; G06F 15/16

(52) U.S. Cl. 715/758

(57) ABSTRACT

A system for conducting chat sessions on a screen, the system comprising apparatus for displaying, on a screen, a plurality of stationary avatars respectively representing a plurality of chat participants over time; and apparatus for displaying, on the screen, a temporal sequence of chat events including a processor operative to utilize stored metadata characterizing each event's position in the temporal sequence and each event's logical association with a respective one of the plurality of avatars to generate a visual representation of the temporal sequence in which both of the following are visually represented simultaneously: each event's position in the temporal sequence; and at least one logical association between each event and a respective one of the plurality of avatars.

### REFERENCE TO CO-PENDING APPLICATIONS

Priority is claimed from Israel Patent Application No. 214855, entitled “A Method And Device For Carrying Out A Computerized Group Session” and filed 28 Aug. 2011.

### FIELD OF THIS DISCLOSURE

The present invention relates generally to computerized systems and more particularly to computerized systems for facilitating group (including two participants) communication via computer, and other electronic devices.

### BACKGROUND FOR THIS DISCLOSURE

Conventional technology pertaining to certain embodiments of the present invention is described in the following publications inter alia:

Existing chat systems include Apple's iMessage, ChatOn, Whatsapp, Facebook messenger and Google chat, icq, windows messenger, groupme, etc. . . . . An avatar is a graphical representation e.g. image drawing or character representing a person.

U.S. Pat. No. 7,478,129 to Chemtob and published United States Patent application 2010/0005402 to George et al describe state of the art computerized systems for facilitating communication between group participants.

The disclosures of all publications and patent documents mentioned in the specification, and of the publications and patent documents cited therein directly or indirectly, are hereby incorporated by reference.

### SUMMARY OF CERTAIN EMBODIMENTS

Certain embodiments of the present invention provide a method for establishing and/or carrying out a computerized group session.

Certain embodiments of the present invention provide a method for interfacing, displaying, managing and conducting chat and other types of group (i.e. multiple users) sessions. The method enables a three dimensional experience for computerized group chats, for users of mobile devices (e.g. smart phones) and/or PC users and/or any other electronic devices (Tablet, TV sets etc.).

Group chats (over mobile and PC) today use platform designed text dialog, basically a scrolling list of the messages up and down the screen. There are various examples for such an interface: windows messenger, Facebook chat, Google talk etc. . . . all of them using similar methods for representing messages and message links to the user.

Certain embodiments of the present invention provide a method that allows graphic display of a group session and messages. The message time line may be “in depth” of the screen, e.g.—the chat is conducted like sitting around a table where each of the users “throws” his message onto the table, and the messages pile up on the table. In addition, the messages are linked to the user who sends them in a way that all the users know who sent each message during the session. In addition, some messages may have a referred to addressee or recipients, which may be graphically visible.

One example of the options provided for carrying out the method of the present invention, which should not be considered as limiting the scope of the invention, is by using a combination that comprises a message placement process, message fade out technique, inherent filtering technique and the fact that the user's animation icons are stationary and may always be seen on screen. The placement process chooses where to place a message according to a foretold set of roles, and a fade out technique creates the effect of a three dimensional experience. This way of representing messages enables the user's Avatar to stay stationary. and still maintain a solid/clear visual connection to messages

Certain embodiments of the present invention enable users to get a quick and clear picture of each others' status (e.g. actions, location in space and surroundings, mood, availability and other attributes), by using icons (e.g Avatar) representing the user, which enhance the three dimensional experience and enable constant feedback regarding or disregarding messages.

The group session method may interface with any application that is used for transferring information over the Internet, LAN (local area network), WAN (wireless area network) or with phone messages (SMS) and voice transfer. This application may operate over any kind of computer platform and operation system (e.g., iOS, Android, Windows, Blackberry, WIN7 etc).

### EXAMPLE

According to one embodiment of the invention, the method comprises the following two rules:
1. The message axis is “in depth” of the screen. Meaning, the older the message is, it may fade away toward the background until it can no longer be seen. When a new message “arrives” as an input, it becomes frontal and in bold, making the effect that it is positioned on top of all other previous messages (e.g “pile” or stack). Messages change their fading level dynamically upon a new message arrival.
As mentioned above, any kind of input may be used to create a message.
The implementation of this technique may be carried out for example, as follows:
   1. One color selected to be the latest message on screen color (for this description—color 1) and second color selected to be the background color (for this description—color 2)
   2. A scale of colors is created between the two colors, where the top most messages may be color 1.
   3. The scale is to be divided into a number of sections by taking equally or not equally spaced points in between the two colors (depending on the number of messages to be presented on screen)—this may be termed “color scale levels”.
   4. Suppose the number of messages is equal to the maximum number of messages that may be presented on screen. When a new message is to be presented, it is designated as “color 1”, while the oldest message that has been on screen for the longest period of time may be removed from the screen and all the other messages may degrade one level in the color scale level.
   5. A shadow may be added to the messages in a way that the top most message on screen gets the biggest or strongest or with largest offset shadow, and similarly to the color scale discussed above, the messages have “shadow scale”. This makes the newer messages look higher relative to the background than the older ones.
   6. The content of the message may also have a “transparency scale” in the same way as the “color scale” and the “shadow scale”.
2. Message placement process—when a new message is introduced to the session room, a process controls the location of messages. The process preferably places the messages in their optimal place according to a foretold set of roles, as long as the new message may be the topmost.
The implementation of such a process may be for example as follows:
   1. Every time a message arrives as an input, the area of the new message is computed, (e.g. in terms of pixels out of the screen area, or part thereof).
   2. The process computes the on-screen free space areas, i.e. the areas where no message is placed when a new message arrives. Thus, one has an array of the place of free rectangles spaces and their areas.
   3. The process preferably takes into consideration only free spaces with sufficient area relative to the new message area in order to consider only areas that may accommodate the newly arriving message. Thus more messages are fully visible on screen.
   4. If no space is found, the process may remove one message from the next computation and then compute the free spaces once again until a sufficient free space has been found.
   5. From the free areas (e.g. rectangles), the process then selects one and inserts the message into that area (the rectangle in this example). The process may take into consideration the following rules for choosing the rectangle:
      The proximity of the rectangle to the linked avatar (the sender)
      The width and height of the free rectangles—to control the minimum width, height and aspect ratio of the messages
      The location of the linked avatar
      The words or content comprised in the message—to avoid breaking words in the middle
      The content/type (e.g text, picture, quick poll etc)

### Example of a Step-by-Step Operation

### Session Initiation:

The interfaced application consists of a centralized server that is capable of providing the conference session flow control and repository of registered users. For the purpose of this example it is assumed that users have registered and downloaded the application to their devices.
Each of the users or the server may initiate a session at any time.
The Initiator may do the following actions while setting the session:
   Use existing group
   Adding participants before or during the session (e.g. the chat)
   Removing a member of the group from the specific session before the session is initiated.

After the session has been initiated, the users may see the avatars of all the users of that session. A user may enter a message at any time. After a message has been entered, the message is placed on the screen and the state of the screen is changed according to the method rules. Thus, the conversation progresses in such a way that the messages come out and fade away from the screen according to the time at which they were entered, creating a three dimensional experience (e.g “pile” or stack).

Each of the users associated with the session may see a different arrangement of the messages, and may navigate between the messages by using any type of controller as known in the art per se.

Each one of the users may, at any time during the session, navigate between messages (take messages on and off the “pile”), enter a message, set attributes for his avatar (e.g. change the picture, change the avatar state) and initiate other features.

### Other Features:

Along with the basic functionality as demonstrated hereinabove, the present invention enables using some other features as well:
1. Quick Poll: this feature enables each one of the users to initiate a poll during the session. The main purpose of this feature is to enable a user to get a quick answer from all the users for any kind of question and to enable all the users participating in the session to see the results of the poll and which of the users replied “yes” and which replied “no”. The quick poll may have the following 3 phases:
   a. Initiation: The initiation of the quick poll is preferably similar to initiation of a regular message. The user may enter a message as a quick poll at any time. From the user's perspective, the difference between initiation of a regular text message or a quick poll may be for example the use of a different button. After one of the users has entered a quick poll message, all the users may see a message with the text that the user entered and buttons in the message space, for example 2 buttons representing “yes” and “no”.
   b. Poll participating: After a quick poll has been initiated, each of the users is able to see the quick poll message on his screen and may push any one of the buttons on the message. After the user has pushed one of the buttons, data may be sent to the server for statistics. The quick poll may also be bound by a pre-determined period of time for a participant to answer the quick poll or any other method to indicate the end of a “quick poll session”.
   c. Poll results: The results may be represented in one of the following 2 ways:
      i. On the avatar—with any kind of sign, for example a badge.
      ii. Summary of the results on the screen that indicates how many users pushed each button.
         The results may be represented at different times and may be discrete or summed such as:
            1. When individual gives result: Result appears when an individual answers (e.g bedge on avatar following a pressed result)
            2. When poll session ends.
2. Referring—Referring is a feature that enables the user to control who may be the recipients (sub-group) of each message, and the way they may get the message (for example—the type of notification for the message). This feature enables reflecting real life conversation to the group session where the relevancy of the messages is dynamic and changes throughout the conversation.
   In the initiation of the message, there may be a way for the user to decide which of the other participants in the session may be able to get the referring message. This may be achieved for example by pressing the recipient's avatars.
   After the user has initiated and sent the referring message, the referring message may have a different indication for the recipients but not for the other users in the session and may be subject to configuration. This indication may be for example—a special sound, a special design for the message, the recipient's names on the message, special notification etc. . . . .
   The referring message may also include a reply button, so that when a user presses the reply button on the message, he may also initiate a referring message intended for the same recipients.
3. Suggested participants—While in conversation, or at the beginning of one, the application may add suggested participants that may appear on screen (or in any other way), these suggested participants' avatars may be, for example grayed-out or faded, which may indicate that they are no longer part of the ongoing discussion. Upon deciding to invite one or more of the suggested participants, the user may be able to easily choose the one(s) to invite.
   Exemplified ways of finding suggested participants:
      a. Choosing participants from an existing group, that has the most in common with the participant(s) of the current discussion.
      b. History of older discussions, phone call, SMS's etc. . . . .
      c. General data collected from one or more data bases.
      d. Data retrieved from external services: Facebook, Mail, Google+, etc. . . . .
      e. A chat using smart phones, desktops or any other means that is connected to the web.

Typically, the application comprises a centralized server that provides the conference chat flow control and repository of registered users. Users may register and download the application into their devices. Any suitable registration process may be used. All messages typically flow through the main server and are distributed to the other users on the chat.

According to certain embodiments, a user sees her or his friends as avatars, while texting—just as if they are all sitting around together. There are no long lists of messages, as the screen looks and feels like a real conversation.

According to certain embodiments, chat participants may interact on multiple levels—talk as a group or in a two-way dialog, toss a comment to a couple of friends, or share a secret with one selected person.

According to certain embodiments, a single cohesive mobile space is provided for multiple users, by engaging in shared or private conversations, all at the same time and place.

It is appreciated that interactive communication has evolved rapidly over the past decade, from email, Internet chat, instant messaging, SMS, to mobile group chats. These services, with the exception of a mobile group chat, have all been served reasonably well by available technology in terms of providing easy-to-use functionality. Supporting mobile group chats, however, is significantly more complex. Mobile group-chat solutions exist which are based on linear conversation flows, creating long lists of communications and resulting in a cumbersome and tedious user experience, “like playing poker on a bar”. Moreover, these solutions involve sharing all messages equally with the entire group, including receipt of notification, despite the fact that too often, a large percentage of messages are irrelevant to each individual user and/or the fact that linear sequencing of messages across all users prevents intuitive presentation of a dialog between two users.

According to certain embodiments, chat participants may interact on multiple levels, just as if they are sitting around together, including some or all of: Talk as a group, or in a two-way dialog e.g. with a sub-group within the group; toss a comment to a couple of friends; or share a secret with one selected person, all at the same time and space.

According to certain embodiments, a game may be played within a chat session, and a display may be provided to the chat participants, including avatars typically arranged around the periphery of the display, and a game state icon typically located in the center of the display which indicates a state of the game. The state of the game may include, inter alia, e.g. a pointer (such as the top of a bottle in a “spin the bottle” game icon) to one or more participants whose turn it currently is. The avatars may be differentially marked e.g. colored to indicate participants' individual game state e.g. which participants are playing and/or who is “up to bat” and/or each participant's score or special game status.

Optionally, at least one of the event icons generated by the system includes a button. For example, if the event is a poll and the icon includes a display of a poll question, the reply buttons may correspond to possible responses to the poll question, such as yes/no. If the event is a game, the reply buttons may correspond to possible game moves.

According to certain embodiments, a computerized system is provided for conducting chat sessions on a pocket-sizedscreen (e.g), the system comprising:

apparatus for generating a display of a group of avatars arranged around a periphery of a screen such as but not limited to a pocket-sized screen; and

apparatus for determining a location at which to display a sequence of messages exchanged between a group of communicators represented by the group of avatars, such that a plurality of message icons representing messages logically associated with an individual avatar visually appears to be associated with the individual avatar, and wherein said determining is based on at least one of predetermined screen space utilization rules e.g. as described herein.

It is appreciated that all references to a pocket-sized screen herein are merely by way of example and are not intended to be limited since the applicability of the present invention also includes screens which are not pocket-sized.

Any suitable method may be employed to determine placement of messages to be displayed, such as but not limited to methods including some or all of the following operations, suitably ordered e.g. as shown:

a. find all free (not occupied by already displayed messages) spaces available to house a message icon e.g. identify all free rectangles in the display screen which are not included in a larger free rectangle.
b. find area required for message icon (also termed herein a “chat bubble”, which may or may not be rectangular) as a function of the length of the text of the message and disqualify all free rectangles found in step (a) whose area is not large enough. Optionally, allowable possible overlap with existing messages, should be taken into account.
c. disqualify free rectangles which do not comply with predetermined aesthetic rules e.g. re width, length and ratio therebetween.
d. select one of the remaining free rectangles in which to house the message icon, using predetermined rules e.g. for preferring rectangles close to the associated avatar.
e. optionally determine extent of overlap with adjacent already displayed messages.

Optionally, differently located portions of different message icons are occluded by respective temporally adjacent message icons e.g., in the oldest message, the lower left portion of the message icon may be occluded by the next oldest message. In the next oldest message, the upper left portion may be occluded by the next next oldest message, whereas in the next next oldest message, perhaps the upper right portion is occluded, and so forth. This allows the message icons in the stack to remain more adjacent to the individual avatar, than would be the case if identically located portions of different message icons (e.g., always the lower right portion) were occluded.

Typically, the font size of all texts in all message icons is uniform or at least is unrelated to the “age” of the message. Alternatively, older messages' texts may be, for example, in a smaller font or font size may change in order to fit a certain free space.

One embodiment of the invention includes placing message icons on an available screen area by first setting the message's dimensions, then placing the message within some or every suitable (using suitable rules to pre-screen unsuitable free spaces) free space or every free space in the available screen area, and scoring the various resulting message positions, using message position scoring rules, to select the final message place.

Suitable rules may include any subset of any of those shown and described herein in any suitable logical combination and applied in any suitable order. Examples of rules include: messages to be placed as close as possible to the virtual line connecting between the sender and the center of the screen; and messages to be then shifted in order to overlap older message (X_MARGIN, Y_MARGIN).

An alternative embodiment of the invention comprises dividing the available screen area into 4 (say) areas and each of 4 (say) users is associated with one such area, whose messages are positioned within ‘his” area, typically a-priori chosen places.

There is thus provided, in accordance with at least one aspect of the presently disclosed subject matter, a system for conducting chat sessions on a pocket-sized (e.g.) screen, the system comprising:

apparatus for displaying, e.g. on a pocket-sized screen or as part of a larger screen, a plurality of stationary avatars respectively representing a plurality of chat participants over time; and

apparatus for displaying, on the screen, a temporal sequence of chat events including a processor operative to utilize stored metadata characterizing each event's position in the temporal sequence and each event's logical association with a respective one of the plurality of avatars to generate a visual representation of the temporal sequence in which both of the following are visually represented simultaneously: each event's position in the temporal sequence; and at least one logical association between each event and a respective one of the plurality of avatars.

There is thus further provided, in accordance with at least one aspect of the presently disclosed subject matter, a system for conducting chat sessions on a pocket-sized (e.g.) screen, the system comprising:

apparatus for displaying a temporal sequence of messages including simultaneously displaying a plurality of message icons representing a corresponding plurality of messages including older messages and newer messages wherein the apparatus for displaying includes a processor determining positioning for message icons such that the older messages' icons visually appear to be deeper than the newer messages' icons, thereby to enhance a viewer's perception of the temporal characteristics of the sequence.

There is thus yet further provided, in accordance with at least one embodiment of the presently disclosed subject matter, a system wherein the older messages' icons are more transparent than the newer messages' icons, thereby to achieve a viewer experience wherein the older messages' icons visually appear to be deeper than the newer messages' icons.

There is thus yet further provided, in accordance with at least one embodiment of the presently disclosed subject matter, a system wherein the temporal sequence of messages is presented on a background having a color and wherein the older messages' icons are more similar to the color than are the newer messages' icons, thereby to achieve a viewer experience wherein the older messages' icons visually appear to be deeper than the newer messages' icons.

There is thus yet further provided, in accordance with at least one embodiment of the presently disclosed subject matter, a system wherein the older messages' icons are partially occluded by the newer messages' icons, thereby to achieve a viewer experience wherein the older messages' icons visually appear to be deeper than the newer messages' icons.

There is thus yet further provided, in accordance with at least one embodiment of the presently disclosed subject matter, a system wherein the icons are shadowed such that older messages' icons are less heavily shadowed (e.g bigger offset and/or stronger in color and/or larger in size) than the newer messages' icons, thereby to achieve a viewer experience wherein the older messages' icons visually appear to be deeper than the newer messages' icons.

There is thus yet further provided, in accordance with at least one aspect of the presently disclosed subject matter, a system for conducting chat sessions, for serving a client having:

a first mode of client operation in which an individual client is inside a chatroom environment in which an ongoing chat session is being held; and

a second mode of client operation in which an individual client belongs to the ongoing chat session but is not in the chatroom, the system comprising:

apparatus for receiving and storing in computer storage, metadata indicating notification options for individual messages; and selective chat message notification apparatus operative, based on the meta-data, to provide to a client in the second mode a push notification that a message has been contributed to the ongoing chat session by a contributing client, but only selectably, depending at least in part on a selection made by the individual client and reflected in the metadata.

There is thus yet further provided, in accordance with at least one aspect of the presently disclosed subject matter, a system for conducting chat sessions on a pocket-sized (e.g.) screen, the system comprising: apparatus for generating a display of a group of avatars arranged around a periphery of a pocket-sized (e.g.) screen; and a location determination apparatus operative to perform location determination for determining a location at which to display a sequence of messages exchanged between a group of communicators represented by the group of avatars, wherein the location determination comprises: using message metadata to identify a plurality of messages which is logically associated with an individual avatar; generating a virtual stack of message icons which visually appears to be associated with the individual avatar.

There is thus yet further provided, in accordance with at least one embodiment of the presently disclosed subject matter, a system wherein the stack is more adjacent to the individual avatar than to other avatars thereby to cause the stack to visually appear to be associated with the individual avatar.

There is thus yet further provided, in accordance with at least one embodiment of the presently disclosed subject matter, a system wherein the location determination further includes using a processor for accessing a stored logical association of the individual avatar with at least one individual message and accessing a stored location of the individual avatar and generating a display in which a message icon in the stack, representing the individual message, is visually connected to the individual avatar thereby to cause the stack to visually appear to be associated with the individual avatar.

There is thus yet further provided, in accordance with at least one embodiment of the presently disclosed subject matter, a system wherein the message icons are stationary on the screen.

There is thus yet further provided, in accordance with at least one embodiment of the presently disclosed subject matter, a system wherein an oldest message icon in the stack is deleted from the screen once a maximum number of newer message icons in the stack have been received and are displayed on the screen.

There is thus yet further provided, in accordance with at least one embodiment of the presently disclosed subject matter, a system wherein a bi-directional user-controlled stack scrolling functionality is provided and wherein, when the stack scrolling functionality is operated in a first, new to old, direction, a newest message icon in the stack is deleted from the screen and a most recently deleted old message icon is restored to the screen, whereas when the stack scrolling functionality is operated in a second, old to new, direction, a newest message icon in the stack is restored to the screen and a most recently restored old message icon is deleted from the screen. This may be done with or without animation and/or visual effect.

There is thus yet further provided, in accordance with at least one embodiment of the presently disclosed subject matter, a system wherein the stack scrolling functionality is actuated by a swipe.

There is thus yet further provided, in accordance with at least one embodiment of the presently disclosed subject matter, a system wherein the stack scrolling functionality is actuated by a virtual button.

There is thus yet further provided, in accordance with at least one aspect of the presently disclosed subject matter, a system for conducting chat sessions on a pocket-sized (e.g.) screen, the system comprising:

apparatus for generating a display of a group of avatars arranged around a periphery of a pocket-sized (e.g.) screen;

apparatus for generating and storing metadata representing a user's selection of a selected avatar from among the group of avatars, and for using the metadata for effecting a user-requested operation on the selected avatar and not for other avatars from among the group of avatars; and

apparatus for displaying messages exchanged between a group of communicators represented by the group of avatars to the user even while the user is performing the operation on the selected one of the group of avatars.

There is thus yet further provided, in accordance with at least one embodiment of the presently disclosed subject matter, a system wherein the apparatus for allowing a user to perform an operation on a selected one of the group of avatars provides a one-click functionality for selecting said selected avatar.

There is thus yet further provided, in accordance with at least one embodiment of the presently disclosed subject matter, a system wherein differently located portions of different message icons are occluded by respectively temporally adjacent message icons, rather than identically located portions of different message icons being occluded, thereby to allow the message icons in the stack to remain more adjacent to the individual avatar, than the message icons would be if identically located portions of different message icons were occluded.

For example, a stack of message icons might be formed by placing each message icon so as to occlude the lower right quadrant of the message icon before it. This may be less effective in allowing the message icons in the stack to remain adjacent to the individual avatar, than if differently located portions of different message icons were occluded e.g. different quadrants or other portions of the message icons. For example, in FIG. 1e, screenshot 2, some messages are not occluded at all such as “who is up for a beer?” and “hey guys . . . ”. Of those messages which are occluded, in some, the bottom portion of the message is occluded; in others, the top portion of the message is occluded.

There is thus yet further provided, in accordance with at least one aspect of the presently disclosed subject matter, a system for conducting chat sessions on a pocket-sized (e.g.) screen, the system comprising: apparatus for generating a display of a group of avatars on a pocket-sized (e.g.) screen; and metadata handling apparatus for storing metadata regarding the avatars, retrieving and displaying the metadata to a chat participant during a chat, and receiving a metadata update from a chat participant during a chat participant and updating the metadata accordingly. There is thus yet further provided, in accordance with at least one embodiment of the presently disclosed subject matter, a system wherein the metadata is specific to at least one individual message sent within the chat and wherein said metadata handling apparatus is operative to display metadata specific to the individual message responsive to a chat participant's selecting an individual message.

There is thus yet further provided, in accordance with at least one embodiment of the presently disclosed subject matter, a system wherein metadata regarding a message is stored even after the message is no longer visible on the screen and wherein the system also comprises message display apparatus which deletes old messages from the screen and identifies a chat participant's scrolling back operation in which the participant scrolls back to an individual message no longer visible on the screen and responsively, restores the individual message, thereby to allow the individual message to be selected by the user, responsive to which the metadata handling apparatus retrieves and displays metadata specific to the individual message.

There is thus yet further provided, in accordance with at least one embodiment of the presently disclosed subject matter, a system wherein the metadata comprise at least one of an acknowledgement that a chat participant has received a chat message sent to her/him; an acknowledgement that a chat participant has read a chat message sent to her/him; and an indication of an emoticon associated by a chat participant with a message sent by her or him.

There is thus yet further provided, in accordance with at least one embodiment of the presently disclosed subject matter, a system wherein the plurality of messages is visually represented as a stack of message icons.

There is thus yet further provided, in accordance with at least one embodiment of the presently disclosed subject matter, a system wherein at least one message icon includes text.

There is thus yet further provided, in accordance with at least one embodiment of the presently disclosed subject matter, a system wherein the screen, which need not be pocket-sized, comprises one of: a mobile communication device screen, a cellular telephone screen, a smartphone screen or a portion of a larger screen (e.g a corner of a computer screen).

There is thus yet further provided, in accordance with at least one embodiment of the presently disclosed subject matter, a system wherein said location determination also comprises determining a message icon location for each of several pairs of first and second temporally adjacent message icons in the stack, such that the first icon occludes the second icon, but only partially, such that a portion of the content included in the second icon is visible despite the first icon.

There is thus yet further provided, in accordance with at least one embodiment of the presently disclosed subject matter, a system wherein a plurality of messages which is logically associated with an individual avatar is visually represented as a stack, which visually appears to be associated with the individual avatar, of message icons, and wherein, for each of several pairs of first and second temporally adjacent message icons in the stack, the first icon occludes the second icon, but only partially, such that a portion of the content included in the second icon is visible despite the first icon.

There is thus yet further provided, in accordance with at least one embodiment of the presently disclosed subject matter, a system wherein the selective chat message notification apparatus is operative, based on the meta-data, to provide the push notification also depending at least in part on a selection made by the contributing client.

There is thus yet further provided, in accordance with at least one embodiment of the presently disclosed subject matter, a system wherein each event's position in the temporal sequence is represented as a virtual depth along a virtual z-axis perpendicular to the screen and wherein at least one logical association between each event and a respective one of the plurality of avatars is represented as a property within the x-y plane of the screen.

There is thus yet further provided, in accordance with at least one embodiment of the presently disclosed subject matter, a system wherein, for at least one logical association, the property within the x-y plane of the screen comprises adjacency within the x-y plane between each event and a respective one of the plurality of avatars which has at least one logical association therewith.

There is thus yet further provided, in accordance with at least one embodiment of the presently disclosed subject matter, a system wherein at least one message is represented by a message icon which remains stationary on the screen until deleted.

There is thus yet further provided, in accordance with at least one embodiment of the presently disclosed subject matter, a system wherein the chat events include at least one message from one chat participant to at least one other chat participant.

There is thus yet further provided, in accordance with at least one embodiment of the presently disclosed subject matter, a system wherein the chat events include at least one game.

There is thus yet further provided, in accordance with at least one embodiment of the presently disclosed subject matter, a system wherein the chat events include at least one poll.

There is thus yet further provided, in accordance with at least one embodiment of the presently disclosed subject matter, a system wherein the avatars are arranged around the screen's periphery.

There is thus yet further provided, in accordance with at least one embodiment of the presently disclosed subject matter, a system wherein the logical association comprises a sender association whereby a message is associated with an avatar because the message was sent by a chat participant represented by the avatar.

There is thus yet further provided, in accordance with at least one embodiment of the presently disclosed subject matter, a system wherein the logical association comprises a recipient association whereby a message is associated with an avatar because the message was received by a chat participant represented by the avatar.

There is thus yet further provided, in accordance with at least one embodiment of the presently disclosed subject matter, a system wherein the recipient association is represented by an avatar property e.g. color.

There is thus yet further provided, in accordance with at least one embodiment of the presently disclosed subject matter, a system wherein the logical association represents a particular response status of a participant corresponding to the avatar, within the poll.

There is thus yet further provided, in accordance with at least one embodiment of the presently disclosed subject matter, a system wherein the logical association represents a state, within the game, of a participant corresponding to the avatar.

There is thus yet further provided, in accordance with at least one embodiment of the presently disclosed subject matter, a system wherein the apparatus for displaying, on a pocket-sized (e.g.) screen, a plurality of stationary avatars is operative to visually display at least one property of an individual chat participant by modifying at least one characteristic of the avatar from among the plurality of stationary avatars which corresponds to the individual chat participant.

There is thus yet further provided, in accordance with at least one embodiment of the presently disclosed subject matter, a system wherein the characteristic comprises a color.

There is thus yet further provided, in accordance with at least one embodiment of the presently disclosed subject matter, a system wherein the characteristic comprises a visual characteristic other than color.

There is thus yet further provided, in accordance with at least one embodiment of the presently disclosed subject matter, a system wherein a message icon is deleted from a chat display when superseded by a predetermined number of messages issued by participants in the chat, such as but not limited to 3, 5, 7, 10 or any other suitable number of messages.

There is thus yet further provided, in accordance with at least one embodiment of the presently disclosed subject matter, a system wherein the response status indicates that the participant did/did not participate in the poll.

There is thus yet further provided, in accordance with at least one embodiment of the presently disclosed subject matter, a system wherein the response status indicates that the participant selected a particular response within the poll.

There is thus yet further provided, in accordance with at least one embodiment of the presently disclosed subject matter, a system wherein the state indicates at least one of the following: the participant is/is not participating in the game, it is/is not currently this participant's turn; the participant's score; the participant's team association if the game is a team game.

There is thus yet further provided, in accordance with at least one embodiment of the presently disclosed subject matter, a system wherein each individual event's position in the temporal sequence is represented by adjacency of an event icon representing the individual event, to other event icons which represent other events which are temporally adjacent to the individual event.

There is thus yet further provided, in accordance with at least one embodiment of the presently disclosed subject matter, a system wherein the system also comprises apparatus for accepting subgroups defined by a chat participant within a chat session by selecting a subset of individual avatars from among the stationary avatars.

There is thus yet further provided, in accordance with at least one embodiment of the presently disclosed subject matter, a system wherein each message logically associated to a specific avatar, subject to at least one constraint including lack of free space, is positioned as close as possible to a line extending from the screen center to the specific avatar.

There is thus yet further provided, in accordance with at least one embodiment of the presently disclosed subject matter, a system wherein subject to at least one constraint including lack of free space, each message is positioned as close as possible to the center of the screen's message area such that messages are perceived to extend from the center of the message area towards the avatar.

There is thus yet further provided, in accordance with at least one embodiment of the presently disclosed subject matter, a system wherein for at least one message icon dimension such as width or length, the dimension is within predetermined bounds and wherein, subject to at least one constraint including lack of free space, the dimension is as close as possible to a predefined ideal size for that dimension.

There is thus yet further provided, in accordance with at least one embodiment of the presently disclosed subject matter, a system wherein the apparatus for accepting subgroups is operative to cause a message defined by a chat participant as “direct”, to be visible as a message icon to all chat participants but to trigger an outside-chat-application notification only to chat participants outside the chat application which belong to a subgroup defined by the chat participant and associated with the message defined by the chat participant as “direct”.

There is thus yet further provided, in accordance with at least one embodiment of the presently disclosed subject matter, a system wherein the apparatus for accepting subgroups is operative to cause a message defined by a chat participant as “private”, to be visible as a message icon, and to trigger an outside-chat-application notification, only to chat participants outside the chat application which belong to a subgroup defined by the chat participant as associated with the message defined by the chat participant as “private”.

There is thus yet further provided, in accordance with at least one embodiment of the presently disclosed subject matter, a system wherein the older messages' icons are partially occluded by the newer messages' icons, thereby to achieve a viewer experience wherein the older messages' icons visually appear to be deeper than the newer messages' icons.

It is appreciated that prior art systems may lack an apparatus for displaying, on a pocket-sized (e.g.) screen, a plurality of stationary avatars respectively representing a plurality of chat participants over time. Instead, an avatar corresponding to a particular chat participant may be generated each time a message from that chat participant is displayed. Also provided is a computer program comprising computer program code means for performing any of the methods shown and described herein when said program is run on a computer; and a computer program product, comprising a typically non-transitory computer-usable or -readable medium or computer readable storage medium, typically tangible, having a computer readable program code embodied therein, said computer readable program code adapted to be executed to implement any or all of the methods shown and described herein. It is appreciated that any or all of the computational steps shown and described herein may be computer-implemented. The operations in accordance with the teachings herein may be performed by a computer specially constructed for the desired purposes or by a general purpose computer specially configured for the desired purpose by a computer program stored in a typically non-transitory computer readable storage medium.

Any suitable processor, display and input means may be used to process, display e.g. on a computer screen or other computer output device, store, and accept information such as information used by or generated by any of the methods and apparatus shown and described herein; the above processor, display and input means including computer programs, in accordance with some or all of the embodiments of the present invention. A web-based system may implement the embodiments shown and described herein, which system may utilize software, computers, routers and telecommunications equipment to operate.

Any or all functionalities of the invention shown and described herein, such as but not limited to steps of flowcharts, may be performed by a conventional personal computer processor, workstation or other programmable device or computer or electronic computing device or processor, either general-purpose or specifically constructed, used for processing; a computer display screen and/or printer and/or speaker for displaying; machine-readable memory such as optical disks, CDROMs, magnetic-optical discs or other discs; RAMs, ROMs, EPROMs, EEPROMs, magnetic or optical or other cards, for storing, and keyboard or mouse for accepting. The term “process” as used above is intended to include any type of computation or manipulation or transformation of data represented as physical, e.g. electronic, phenomena which may occur or reside e.g. within registers and/or memories of a computer or processor. The term processor includes a single processing unit or a plurality of distributed or remote such units.

The above devices may communicate via any conventional wired or wireless digital communication means, e.g. via a wired or cellular telephone network or a computer network such as the Internet.

The apparatus of the present invention may include, according to certain embodiments of the invention, machine readable memory containing or otherwise storing a program of instructions which, when executed by the machine, implements some or all of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may, wherever suitable, operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless specifically stated otherwise, as apparent from the following discussions, it is appreciated that throughout the specification discussions, utilizing terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining” or the like, refer to the action and/or processes of a computer or computing system, or processor or similar electronic computing device, that manipulate and/or transform data represented as physical, such as electronic, quantities within the computing system's registers and/or memories, into other data similarly represented as physical quantities within the computing system's memories, registers or other such information storage, transmission or display devices. The term “computer” should be broadly construed to cover any kind of electronic device with data processing capabilities, including, by way of non-limiting example, personal computers, servers, computing system, communication devices, processors (e.g. digital signal processor (DSP), microcontrollers, field programmable gate array (FPGA), application specific integrated circuit (ASIC), etc.) and other electronic computing devices.

The present invention may be described, merely for clarity, in terms of terminology specific to particular programming languages, operating systems, browsers, system versions, individual products, and the like. It will be appreciated that this terminology is intended to convey general principles of operation clearly and briefly, by way of example, and is not intended to limit the scope of the invention to any particular programming language, operating system, browser, system version, or individual product.

Elements separately listed herein need not be distinct components and alternatively may be the same structure.

Any suitable input device, such as but not limited to a sensor, may be used to generate or otherwise provide information received by the apparatus and methods shown and described herein. Any suitable output device or display may be used to display or output information generated by the apparatus and methods shown and described herein. Any suitable processor may be employed to compute or generate information as described herein e.g. by providing one or more modules in the processor to perform functionalities described herein. Any suitable computerized data storage e.g. computer memory may be used to store information received by or generated by the systems shown and described herein. Functionalities shown and described herein may be divided between a server computer and a plurality of client computers. These or any other computerized components shown and described herein may communicate between themselves via a suitable computer network.

### BRIEF DESCRIPTION OF THE DRAWINGS

Certain embodiments of the present invention are illustrated in the following drawings:

FIG. 1a is a screenshot of a session (conversation or image sharing, etc) of multiple users in which messages (4-10) are linked to avatars and shown chronologically by using gradual fade out technique. In the illustrated example, message 4 is the most recent and message 5 is oldest that may be seen on the messages space (2).

FIG. 1b is a simplified flowchart illustration of an example of a process for message placement according to certain embodiments.

FIG. 1c is a pictorial illustration of a system in which all messages flow through the main server and are distributed to the other users logged on the session (chat).

FIG. 1d is a pair of screenshots which shows the placement of an initial message.

FIG. 1e is a sequence of screenshots which shows a conversation in progress.

FIG. 1f shows an example icon of a quick poll message.

FIG. 1g is a screenshot of an example of a quick poll.

FIGS. 2a-2c show an example sequence of display screens which may be generated when initiating a discussion.

FIGS. 3a-3i show an example general flow and GUI of a conference chat from the moment it has been initiated by the user. Discussion Screens, with reference to in which (example) colors used to indicate properties, are abbreviated as BL, OR, GR for blue, orange, gray respectively. In particular:

FIG. 3b illustrates the flow of FIG. 3a where Arnon initiate conversation. Arnon may see the participants in gray like in the Fig. or may see the participants in a long list and chose from the list. After he chooses the participants he can initiate the conversation.

FIG. 3c illustrates the flow of FIG. 3d where Udi is adding participant (Gal) during the chat.

FIG. 3e illustrates the flow of FIG. 3f abstract flow of the messages.

FIG. 3g illustrates the flow of FIG. 3h—termination of phone from the conversation.

FIG. 3i represent optional illustrations of screens from which a user may select a conversation.

FIGS. 4-8 are simplified flowcharts illustrating example methods for determining suitable message icon positions for each of a temporal sequence of messages. All methods represented herein by flowcharts typically comprise some or all of the illustrated steps, suitably ordered e.g. as illustrated.

FIGS. 9a-16b are pictorial illustrations of examples useful in understanding methods for determining suitable message icon positions for each of a temporal sequence of messages, such as the methods of FIGS. 4-8.

FIGS. 17a-18 are diagrams of an example data structure useful in implementing certain embodiments of the present invention.

FIGS. 19a-23f are illustrations useful in understanding the operation of a server component constructed and operative in accordance with an embodiment of the present invention.

FIGS. 24a-24e are example screenshots and other diagrams useful in understanding example methods and flows provided in accordance with certain embodiments of the present invention.

FIG. 25 is an example screenshot of a game being played within a chat session, wherein a state of the e.g. a pointer (such as the top of a bottle in a “spin the bottle” game icon) is shown to participants.

Computational components described and illustrated herein can be implemented in various forms, for example, as hardware circuits such as but not limited to custom VLSI circuits or gate arrays or programmable hardware devices such as but not limited to FPGAs, or as software program code stored on at least one intangible computer readable medium and executable by at least one processor, or any suitable combination thereof. A specific functional component may be formed by one particular sequence of software code, or by a plurality of such, which collectively act or behave or act as described herein with reference to the functional component in question. For example, the component may be distributed over several code sequences such as but not limited to objects, procedures, functions, routines and programs and may originate from several computer files which typically operate synergistically.

Data can be stored on one or more intangible computer readable media stored at one or more different locations, different network nodes or different storage devices at a single node or location.

It is appreciated that any computer data storage technology, including any type of storage or memory and any type of computer components and recording media that retain digital data used for computing for an interval of time, and any type of information retention technology, may be used to store the various data provided and employed herein. Suitable computer data storage or information retention apparatus may include apparatus which is primary, secondary, tertiary or off-line; which is of any type or level or amount or category of volatility, differentiation, mutability, accessibility, addressability, capacity, performance and energy use; and which is based on any suitable technologies such as semiconductor, magnetic, optical, paper and others.

### DETAILED DESCRIPTION OF CERTAIN EMBODIMENTS

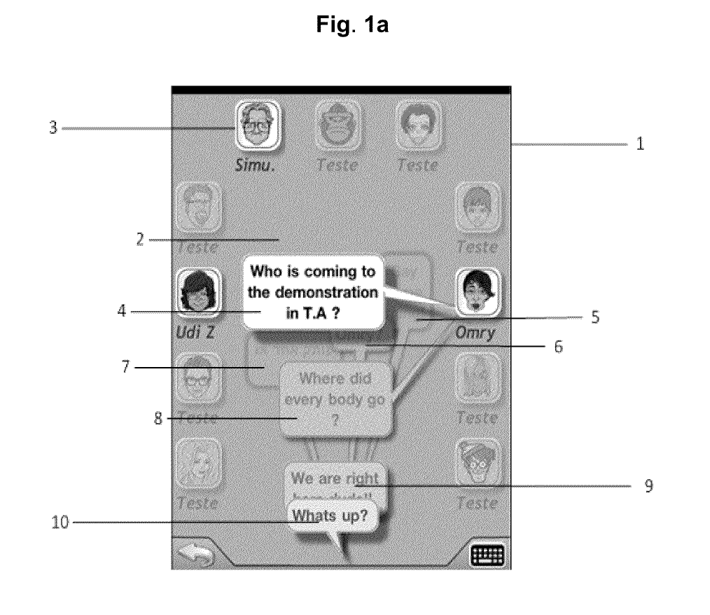

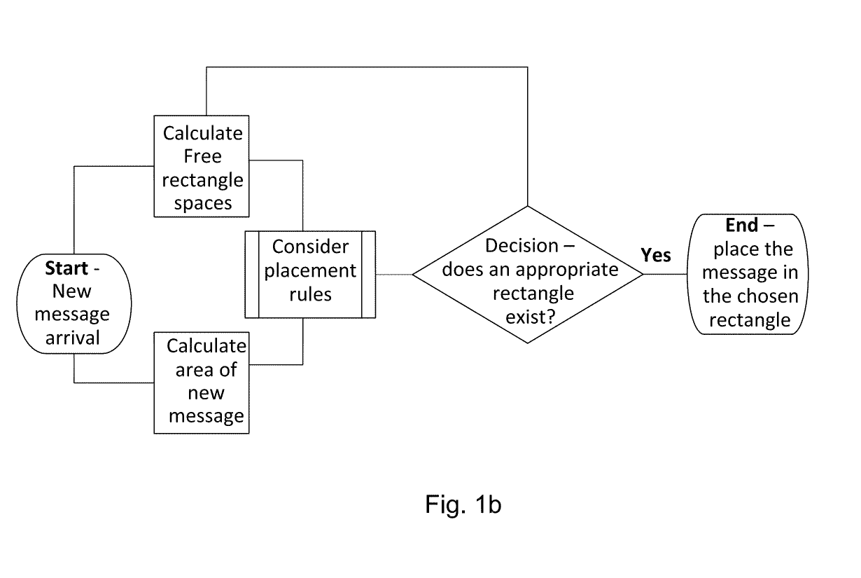

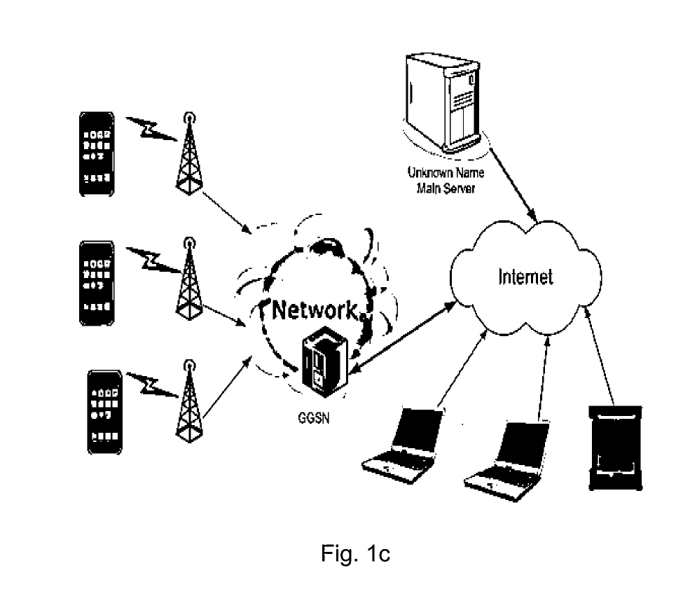

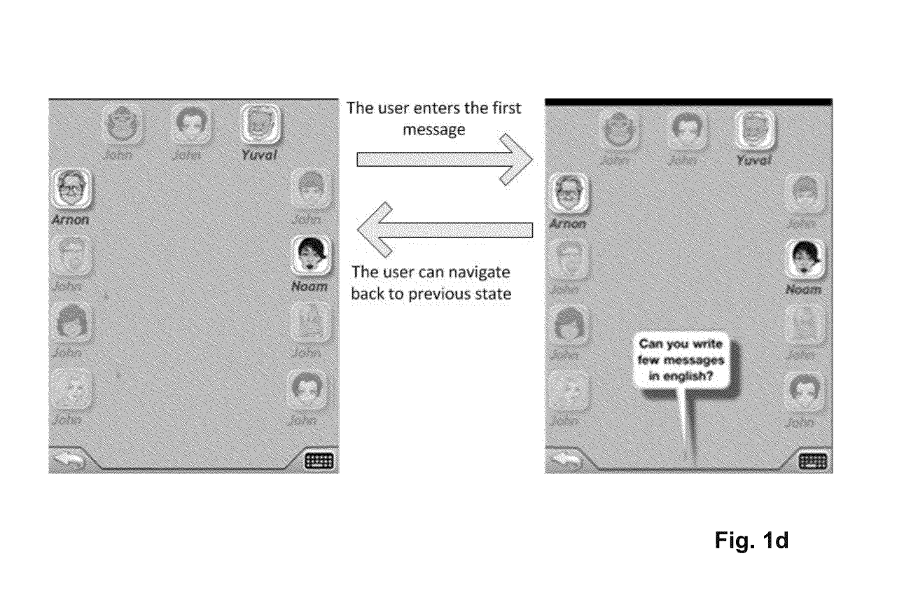

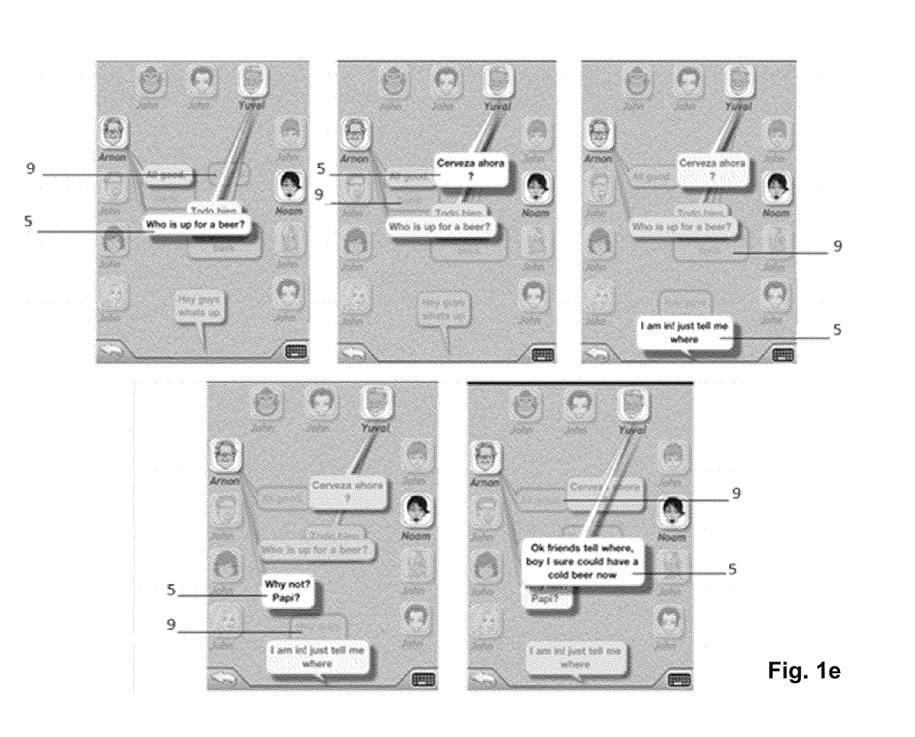

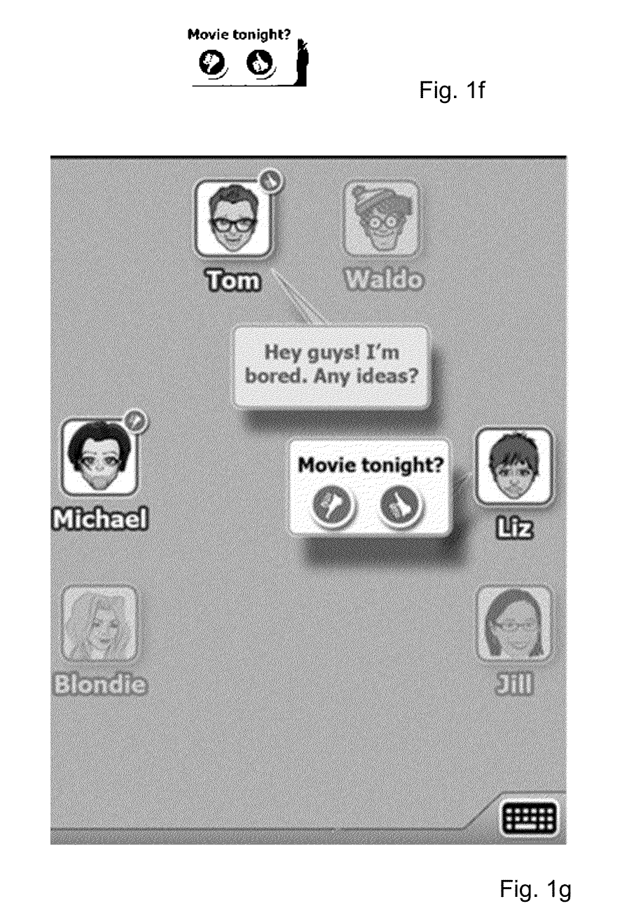

Components of certain embodiments of the present invention are now described:
The session room (FIG. 1a, at reference numeral 1) comprises the elements of the group session including: messages space (FIG. 1a, at reference numeral 2), avatars (FIG. 1a, at reference numeral 3) and messages (FIG. 1a, at reference numerals 4-10). The discussion room may also comprise other features for example buttons, space for input, background, controllers, etc.
Messages space (FIG. 1a, at reference numeral 2) is the space between the avatars (FIG. 1a, at reference numeral 3) at which the messages (FIG. 1a, at reference numerals 4-10) are placed.
Avatars (FIG. 1a, at reference numeral 3) represent the users participating in the session. An avatar may be a picture of the user, a drawing, a name or a moving figure. Optionally, the avatar is able to indicate the user's current action (e.g., driving, shopping, jogging), location in space and surroundings (e.g. home, office), mood, availability and other predetermined attributes.
Messages (FIG. 1a, at reference numerals 4-10) are initiated by a user and broadcast to all the users defined in the session. The message may be in any form, including without limitation, text, picture and/or video. The message may be linked to the avatar who created it, and visible to others. The input for the message may be any form of input e.g.—keyboard, voice and photos. The number of on screen messages may vary according to the session screen size and the messages' size.
FIG. 1b is a simplified flowchart illustration of an example of a process for message placement according to certain embodiments.

FIG. 1c is a pictorial illustration of a system in which all messages flow through the main server and are distributed to the other users logged on the session (chat).
FIG. 1d is a pair of screenshots which shows the placement of an initial message. The user may navigate back and forth using the controllers.
FIG. 1e is a sequence of screenshots which shows a conversation in progress, where 5 is always the topmost message and 9 is the oldest that may still be seen on screen. The placement of messages and the gradual fading out effect (the three scales—color, shadow and content transparency), as well as the linking to avatars, is shown.
FIG. 1f shows an example icon of a quick poll message. The users may press the “yes/no” buttons and this data may appear on the screen.
FIG. 1g is a screenshot of an example of a quick poll. Liz initiated the poll, Tom answered yes and Michael answered no.

The system of the present invention may include a software platform having some or all of the following entities:

1. User
This refers to the unique entity that relates to a real person, and is a digital definition of the person that uses the platform.

2. Contact
This refers to the data structure that saves a contact person's information. Typically, it is not a public entity and only exist for a user. Also typically, a contact is private to the user's phone unless the user decides to share or send it. A user may add any kind of information about a person within the contact that describes him.
The basic ID for a contact may be its phone number as a unique ID. This ID may enable a connection between contacts and participants. Typically, the phone's inherent contacts are used for the platform.
Contact Properties may be driven by and therefore the same as the phone's contact properties.

3. Group (of Contacts)
A group is a set, typically user-defined, of contacts.
A group is typically private to the user's phone unless the user decides to share or send it. A group is defined by a name e.g. “my class”, “my family”, “bowling partners”. Typically, a group is not a public entity and may not by any (direct) means be disclosed to a different user; it only lives on the user's phone.
Group Properties stored in computer memory may include some or all of:
   Name—as defined by the user (or suggested)
   Level of openness—as a default for discussions that are opened based on the group. A group may be a ‘seed’ for a discussion.
   Additional information—the user is typically able to add information to describe a group such as but not limited to description, photo, video.

Suggested Groups
The application may suggest groups for the user. The user may have the option to save, change and use the suggested groups, e.g.:
   The company data base—for example: a user's contact group information, “my friend's groups”
   based on Phone call statistics: approximate calls, amount
   Text message statistics
   social network e.g. Facebook data base
   Mail contacts data base

4. Discussion
This refers to a public and dynamic entity, typically online, that enables interaction between different participants. Typically, it is a virtual entity that only exists while there are participants in it. Typically, a discussion is formed by a user, and is (usually) seeded by a group as defined by the user e.g. as described below, but from there on, a discussion is typically a separate entity. Any form of interaction may occur on top of a discussion and between its participants. The panel of participants within a discussion may change while the discussion is ongoing.
The discussion is optionally absolute, meaning that every participant sees everyone in it and every event on it other than those events specially defined by a user, as secret or private.
Discussion Properties stored in a computer memory may include some or all of:
   Initiator—the user that started the discussion
   Level of openness—refers to the level of interaction the discussion may be spread. The lowest level says that after initiation no new participants may join.
   Real time: Does the interaction require real time properties (for games for instance)
   Media types—what types of media may be published within the discussion (such as but not limited to text, voice, location, pictures, video).
Although a discussion may seed from a group; a discussion is an autonomic entity and may be initiated regardless to the existing of a group. The user may select participants (for example from a list) and initiate a discussion and start sending messages into that discussion. Provision of the group entity is not mandatory but is useful for the user's convenience to define his friends in groups.

5. Participant
Typically, the avatar of a user during a discussion, is an online entity that only exists within a discussion. A participant is connected to and driven by a specific user. A participant may create events over a discussion which may then be published to the other participants of the same discussion.
   Users may be active in several discussions at a time. In each discussion the user may be represented as a participant. Typically, each user may have only one participant in each discussion. Typically, a participant may have different qualities for different discussions depending on the desired definitions given by its user. Typically, the linkage between a user, contact and participant is through their unique ID which is a phone number. establishment of this linkage and effects thereof are described below.
   Participant Properties stored in a computer memory may include some or all of:
   Typically, much of the data is assigned to a participant through linkage to an individual contact within a user's phone, therefore he/she need not be a part of the participant properties. Properties may include:
      Log in state: Not active, Passive, Busy.
      Location
      Movement state
      Feeling

6. Discussion Screen
This refers to a “window” for a discussion, enabling a user to see the communication and interaction between participants and take action.
The discussion window may show some or all of:
   All the participants of the discussion.
   Communication and interaction between the participants
Processes in the platform may include some or all of:

1. Registration
This may be similar to “Whatsapp?” or “Viber” which are applications that use a phone number as a unique ID. Registration may be through email and password, through facebook, twitter or any other method for providing a unique ID. Typically, a user provides as little information as possible; instead, information is gathered automatically. At the end of the registration process, the data base typically has a new user which is defined by his phone number or by any of the above (email, facebook account etc.). Optionally, a user is asked to provide a name. The flow of registration may include some or all of the following operations, suitably ordered e.g. as follows:
   a. Allowing Push notification
   b. Allowing app to use contacts
   c. Entering new user's phone number manually
   d. Access code is sent to new user via SMS
   e. Entering the access code

2. Forming a Group
Formation of groups may be enabled by the user and saved on the device. Modes of operation whereby to form and save a group may include any or all of:
   Manual—Choosing contacts manually and defining them as a group, providing title and additional information to the group, e.g. using multiple choice
   Semi-Automated—During a discussion, the user may be able to choose to save all the active participants as a group, and then provide a name and additional information, if desired. The group may be formed of contacts linked to the current participants (via ID).
   Automated—electing to save a suggested group as regular group.

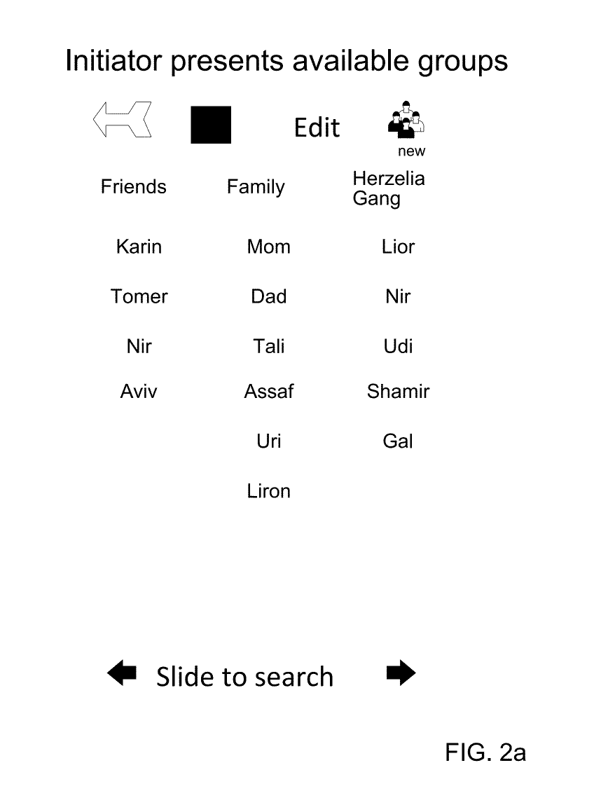

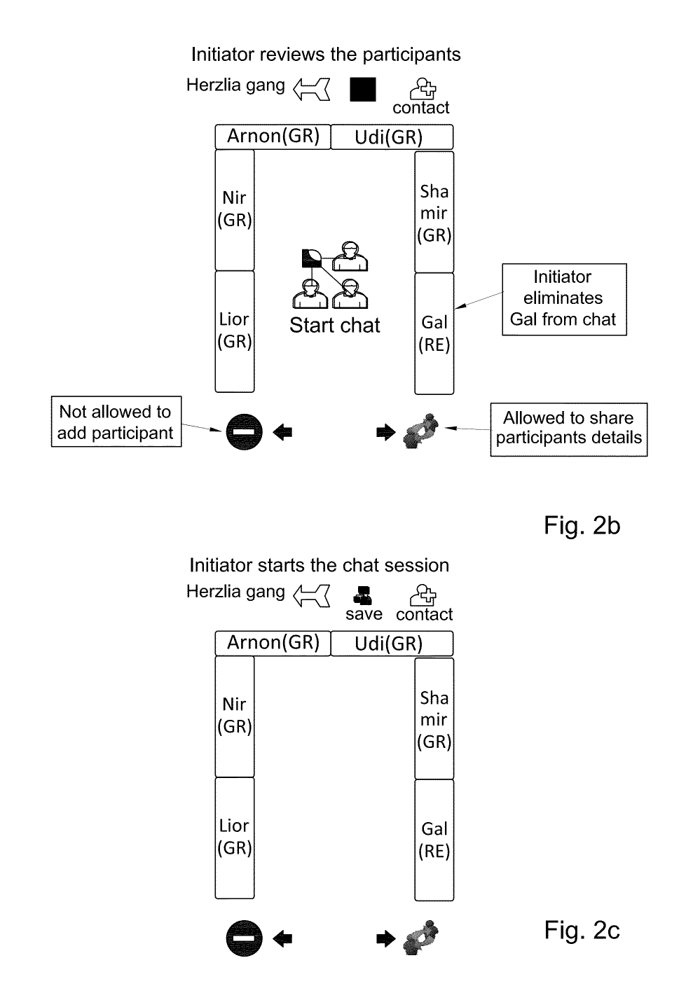

3. Initiate a Discussion
Typically, a user is able to initiate a discussion. Typically, a user indicates the first participants that he wants to be involved with.
How a user may choose initial participants:
   choosing a group.
   The group chosen may be editable for the specific discussion being initiated (not changing the group entity). Typically, the user may be able to do some or all of: Add a contact, remove and add another group.
The intended participants are contacts at this point, until the discussion is initiated.
   Choosing participants of the discussion from a list
The user may be able to provide, if s/he desires, properties for the discussion.
The actual initiation may include enabling the first communication event (e.g. writing a message), and pressing SEND. At this point a discussion is formed and the contacts chosen turn into participants.
An example sequence of display screens which may be generated when initiating a discussion is shown in FIGS. 2a-2c. In FIG. 2a, the initiator presents available groups. The initiator in the illustrated example chose “Herzlia gang” group, consisting of his friends residing in his home town of Herzlia, Israel, or “family” consisting of his family members. The group then opens on the screen e.g. as shown in FIG. 2b and the initiator may review the participants. The initiator then starts the chat session as shown in FIG. 2c, e.g. by clicking on a start chat button, after eliminating, say, his former friend Gal, e.g. by clicking on Gal's avatar. Gal's avatar therefore appears in FIG. 2b but not in FIG. 2c. In these drawings and others, the screen portion corresponding to each participant is represented, for simplicity, as a blank space rather than as an avatar.

4. Receiving a Discussion
If an individual is at a receiving side of a discussion, it means s/he did not initiate it. Typically, by receiving a discussion, the individual is actually asked to join it as a participant.
The user receiving a discussion may have a push notification with the last message that was broadcast in the discussion, and may be asked to join.
If the user chooses to join, the discussion screen may appear and the user may become a participant.
At this point the discussion screen may contain all the participants of the discussion and may also include:
   pop up of the group and optionally a name as defined by the receiving user with the most common contacts that are now participants in the discussion received, and/or
   if a contact in a popped group is a participant in the discussion it may show him as active, otherwise it may show him (contact) as non-active.
Typically, if a user receives a discussion and agrees to join it, he becomes a participant in the discussion.

5. Adding a Participant
Typically, it is possible to add a participant to a discussion after its initiation and until the discussion ends. Optionally, adding is possible if permissions allow it. Adding a participant may for example comprise:
   Choosing a non-active contact within the discussion screen.
   Choosing a contact from the list of contacts or other groups (outside the discussion screen)
After the new participant is asked to join, s/he typically receives the discussion, with the last message, but typically without the history of the discussion. The discussion screen of all other participants is then updated for the newly joined participant, who typically pops up.

6. Time Line
A time line of events of a discussion may be saved, and the user may be able to scroll through the history of the discussion. In the discussion screen there may be a controller that enables this navigation.

7. Closing a Discussion
Communication\Events typically include whatever happens on top of a discussion and between its participants, such as but not limited to:
1. Message
   a. Target? (Referring to someone while texting)
   b. Transparent/Confidential/secret
2. Gestures
3. Data, Media
   Level of interaction/participants refers to the hierarchy of the participant of a dynamic discussion and may be appropriately defined and may include Permissions.

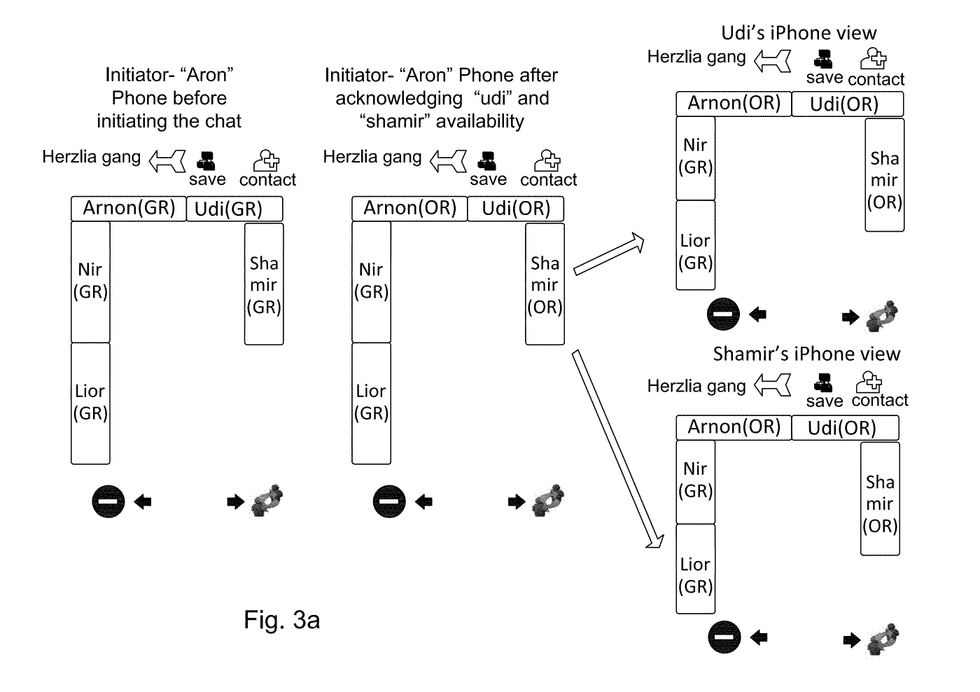

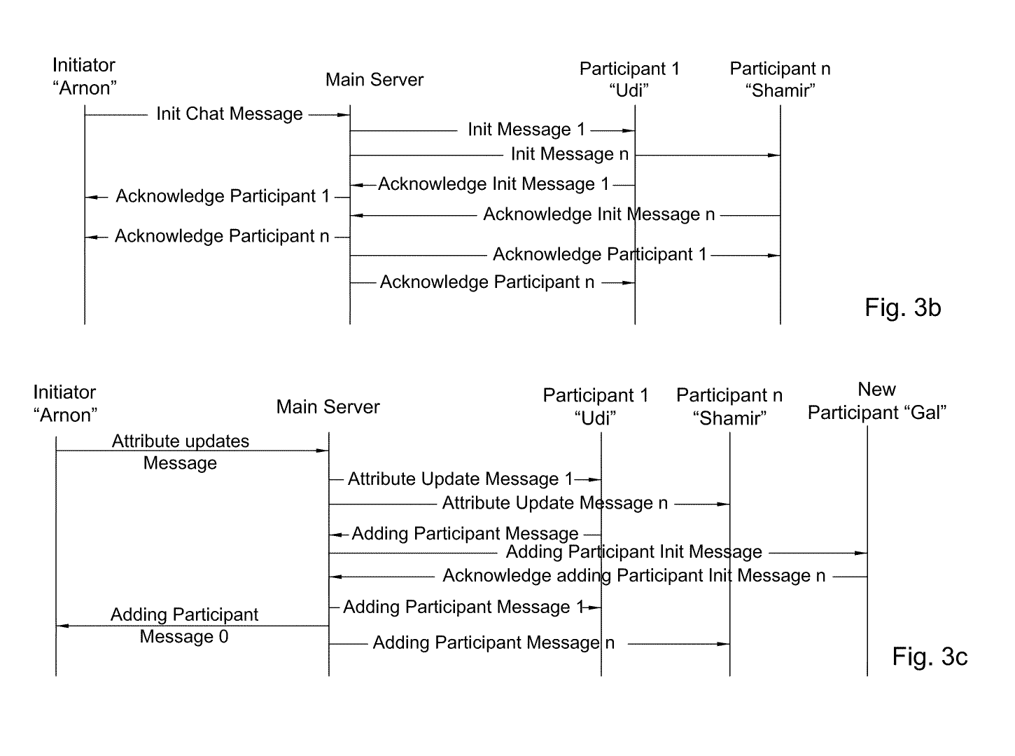

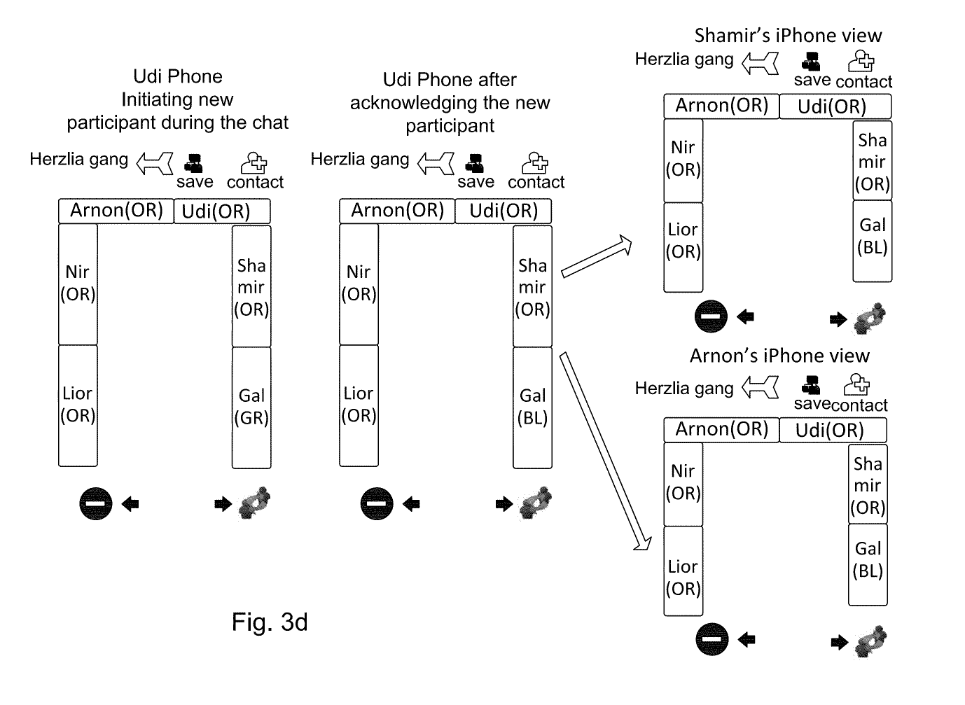

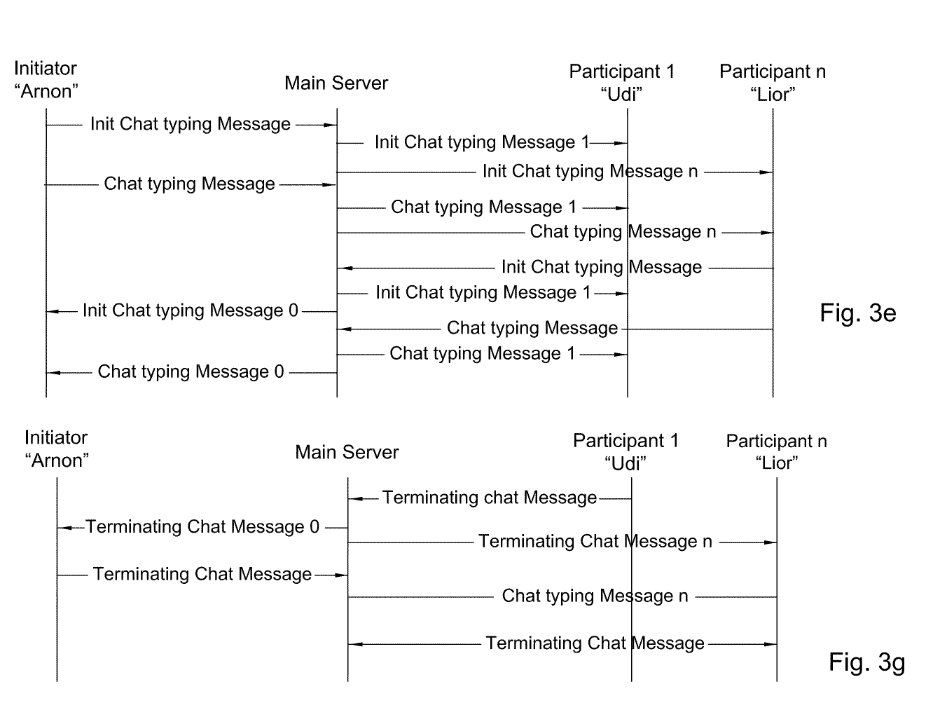

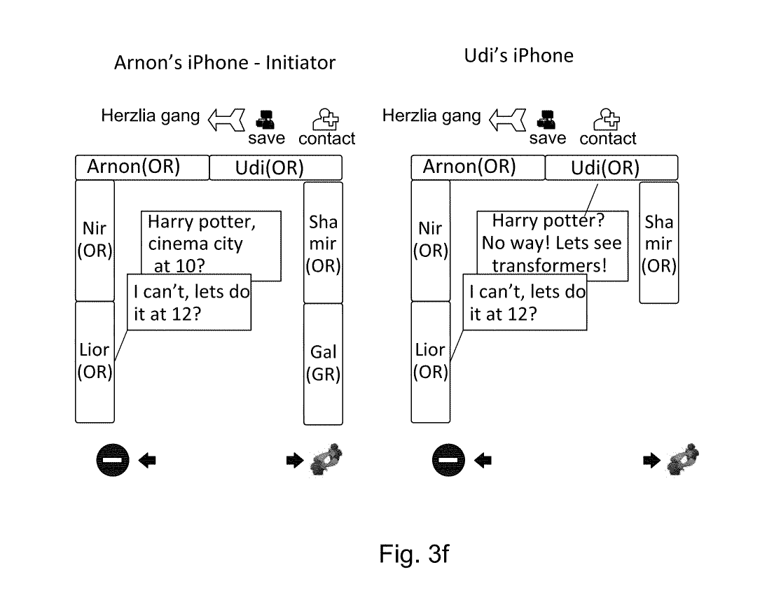

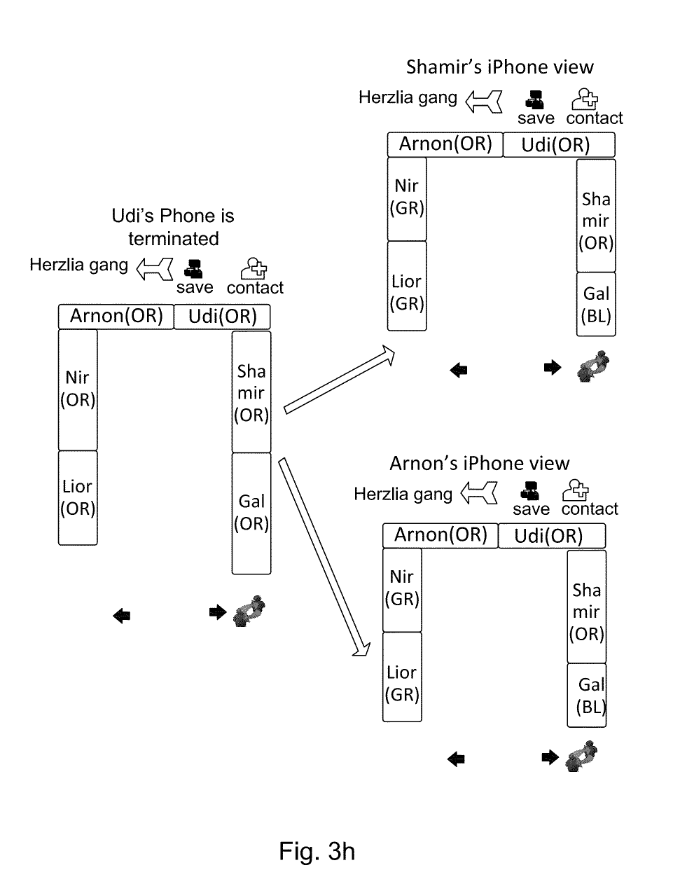

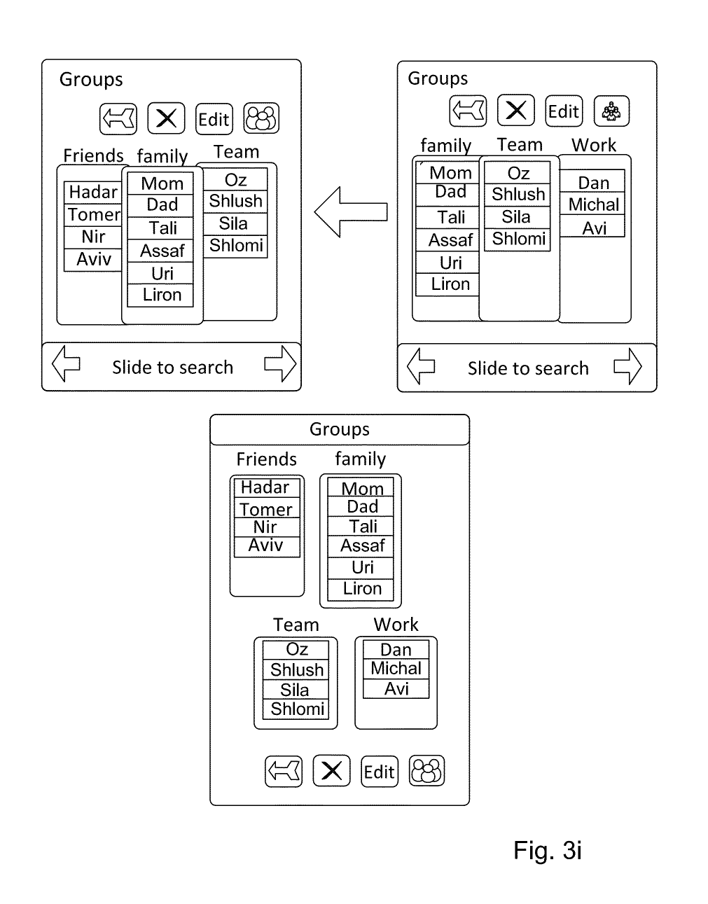

An example general flow and GUI of a conference chat from the moment it has been initiated by the user, and suitable example Discussion Screens, are now described, with reference to FIGS. 3a-3i. The general flow may include initiating the chat session, conducting or holding the session including, for example, adding a participant and terminating the chat session.

### Initiating a Chat Session:

An Initiator (e.g. “Arnon”) may perform any or all of the following actions while setting the chat:
Using existing group
Adding participants before or during the chat
Removing a member of the group from the specific chat before the chat is initiated
Setting attribute for close/open chat
Setting attribute for sharing/not sharing participants details
   A discussion initiation process may be as per FIGS. 2a-2c and 3a. Some or all of the following information may be transferred during the chat initiation
   <Init Chat Message>-Participant_{—}1 Phone, Participant_{—}1 IP address, Participant_{—}1 Name; Participant_n Phone, Participant_n IP address, Participant_n Name [Attributes-participants (open/close); sharing details (yes/no);]
   The connectivity may be through the Participant IP address and it may provide the option to chat with laptop, iPad users, ipod, and any other smart phone devices. Color representation may be used e.g.:
Initial Participant Color->Unconnected State->Initial color->Gray.
Removing a member of the group->his connectivity details may not be distributed->changing his color to “red”
Receiving of Init Chat Message->Audible Alarm->Application popup from it standby condition.
Receive of Acknowledge Init Message->Participant is connected->Participant's color is changed to active status (“orange”) in all active participants' screens.
   The diagram of FIG. 3b presents an example flow of chat initiation.
   Adding a participant to a chat session may for example have some or all of the following stages or characteristics: During the call an additional participant may be added by the initiator or by any of the other participants, typically if the [Attribute-participant] is OPEN. Once a user in session decides to add a new participant, he may choose such a participant from his Contacts List. The initiator may change the [Attribute-participants (open/close)] to OPEN by <Attribute update Message>[Attributes-participants (open/close); sharing details (yes/no);]
Adding Participant->Contact List->Adding New Participant Icon “gray”->Send <Adding Participant Message>Participant_{—}1 Phone, Participant_{—}1 IP address, Participant_{—}1 Name

The newly added participant/s gets the attribute of the session for sharing/not sharing of participant details.
optional sequence: Receive of Adding Participant Message->Audible Alarm->Application popup from its standby condition.
optional sequence: Receive of Acknowledge Adding Participant Message->Participant is connected->Participant's color is changed to active status (“blue”) in all active participants' screens, indicating that it is not part of the original group.
   The diagram of FIG. 3c presents an example flow for changing an attribute and adding a participant; example screen displays which may result from this process are shown in FIG. 3d.

An example of conducting a chat session is now described with reference to FIGS. 3e-3f. As shown in FIGS. 3e and 3f, once a chat session is established, each of the participants may initiate a chat message. Once a user starts to type a message, a <Init Type Chat Message>is sent by the user to the server indicating the preparation of a new message, e.g.: <Init Type Chat Message>Participant Name

A <Init Type Chat Message-i>may be sent to each participant from the main server synchronizing the chat session between the users. The specific participant icon color is changed to “green” and once the message is received, the color is changed back to “orange”. In parallel, a message appears on the screen notifying that the participant “name” is typing a message. Terminating a chat session may for example proceed as per FIGS. 3g, 3h or any portion thereof. Each of the users may terminate himself from the session. A message <Terminate Chat Message>participant name may be sent to the main server and a message is <Terminate Chat Message_i>participant name may be sent to other participants. The icon of the terminated participant may become, say, gray (GR). Once all participants have indicated that the session has terminated, the session ends. Adding a group of chat session: A user may add the group as a new group or update existing group on his Smartphone by clicking on the sharing icon, if it appears. Participants that do not exist on his phone may be automatically added to his contact list. Examples of possible group screens are shown in FIG. 3i.

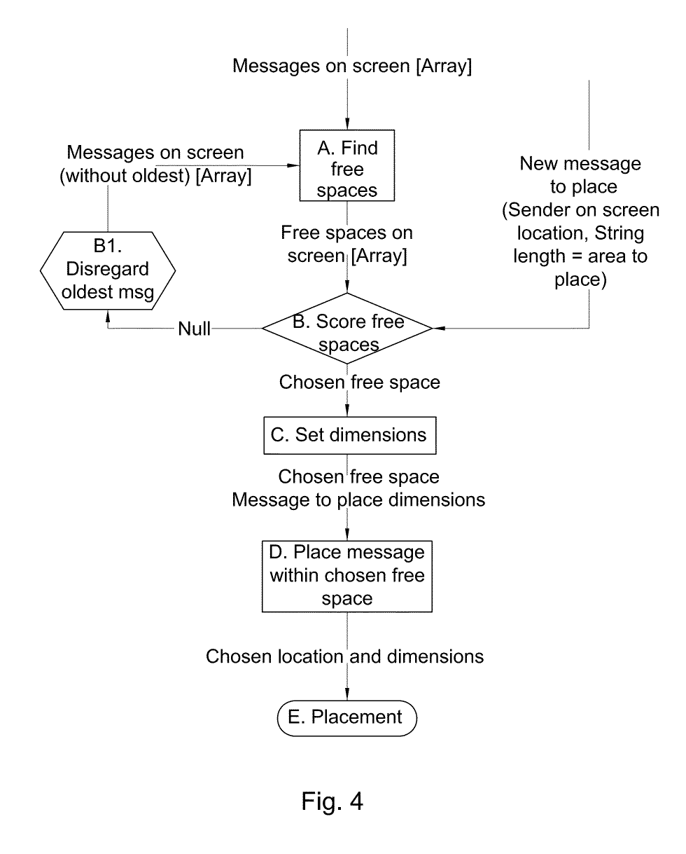

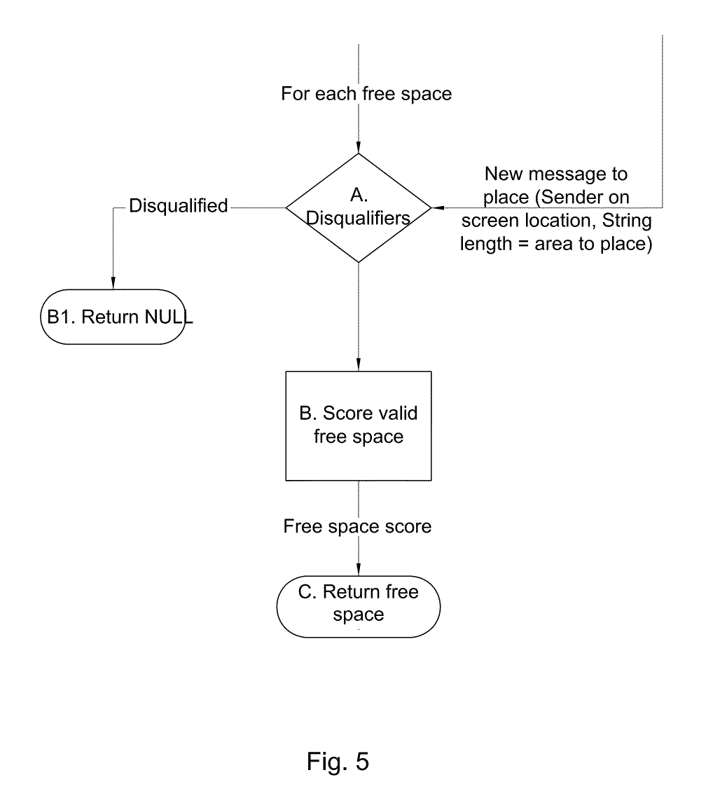

FIG. 4 is a simplified flowchart illustration of an example chat message positioning method for a computerized chat system constructed and operative in accordance with an embodiment of the present invention. Step A, finding free spaces available for displaying a chat message, may be performed conventionally, e.g. as described in the following publication: “Free Space Modeling For Placing Rectangles Without Overlapping”, Bernard, M. And Jacquenet, F., Journal Of Universal Computer Science, vol. 3, no. 6, 1997, pp. 703-720, and particularly at paragraph 3-3.3 on page 7 thereof. Step B, scoring free spaces, may comprise the method of FIG. 5.

FIG. 5, then, is a simplified flowchart illustration of an example method for performing the free space scoring step B of FIG. 4. In step A of FIG. 5, any suitable set of disqualifiers may be employed to disqualify some of the free spaces found in step A of FIG. 4, such as some or all of the following disqualifiers:
i. Free space area is too small to fit the new message
ii. Free space is too narrow (MIN_WIDTH)
iii. Disproportional height to width (HEIGHT_TO_WIDTH_MAX_PROPORTION)
iv. Free space is too low (MIN_HEIGHT)
v. Distance of free space from user location is too far (MAX_DIS_CHOOSE)
   In step B1 of FIG. 5, a “null” score is assigned to disqualified free spaces.
   In step B of FIG. 5, non-disqualified or “valid” free spaces are assigned a score. For example, the following formula may be employed:

score=DIS_USER_WEIGHT*(dis_from_user)+DIS_CENTER_WEIGHT*dis_from_center;

It is appreciated that alternatively, any other scoring formula may be used such as some other increasing function of some or all of DIS_USER_WEIGHT, (dis_from_user), DIS_CENTER_WEIGHT and dis_from_center.

In step C, the free space with the highest score is returned and is regarded as the chosen free space.

Referring again to FIG. 4, in step C, dimensions for the message to be displayed are now set within the chosen free space returned by step C of FIG. 5, using any suitable method such as but not limited to use of the following rules I-iv, in any suitable order or prioritization e.g. that shown below:
i. If width (of text in one row)<PREFER_WIDTH then set this width and a one row height
ii. If fits in PREFER_WIDTH, and the resulted height fits then set
iii. If free-space width <PREFER_WIDTH, then set the free-space width
iv. If the width result is bigger than MAX_WIDTH, then set MAX_WIDTH

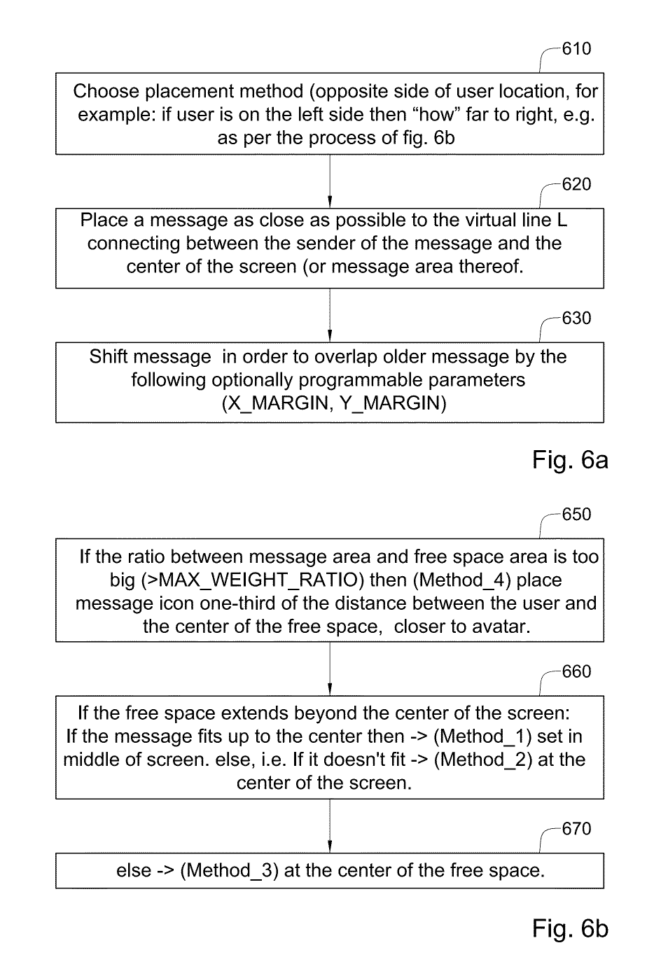

In Step D of FIG. 4, the method places the message within free space. The method of step D may include some or all of the steps of the methods of FIGS. 6a-6b, suitably ordered e.g. as follows:

In FIG. 6a:

610: Choose placement method (opposite side of user location, for example: if user is on the left side then “how” far to right, e.g. as per the process of FIG. 6b
620: Place a message as close as possible to the virtual line L connecting between the sender of the message and the center of the screen (or message area thereof.
630: Shift message in order to overlap older message by the following optionally programmable parameters (X_MARGIN, Y_MARGIN)

In FIG. 6b

650: If the ratio between message area and free space area is too big (>MAX_WEIGHT_RATIO) then (Method_{—}4) place message icon one-third of the distance between the user and the center of the free space, closer to avatar.
660: If the free space extends beyond the center of the screen:

If the message fits up to the center then->(Method_{—}1) set in middle of screen. else, i.e. If it doesn't fit->(Method_{—}2) at the center of the screen. It is appreciated that the term “Center” refers to is the center point of the screen whereas “middle” can refer to the middle of the x axis or y axis.

670: else->(Method_{—}3) at the center of the free space.

Example Parameters:

### MIN_WIDTH=40

### HEIGHT_TO_WIDTH_MAX_PROPORTION=2

MIN_HEIGHT=25 (line)

### MAX_DIS_CHOOSE=250

### PREFER_WIDTH=100

### MAX_WIDTH=220

### MAX_WEIGHT_RATIO=15

### X_MARGIN=4

### Y_MARGIN=4

### DIS_USER_WEIGHT=4

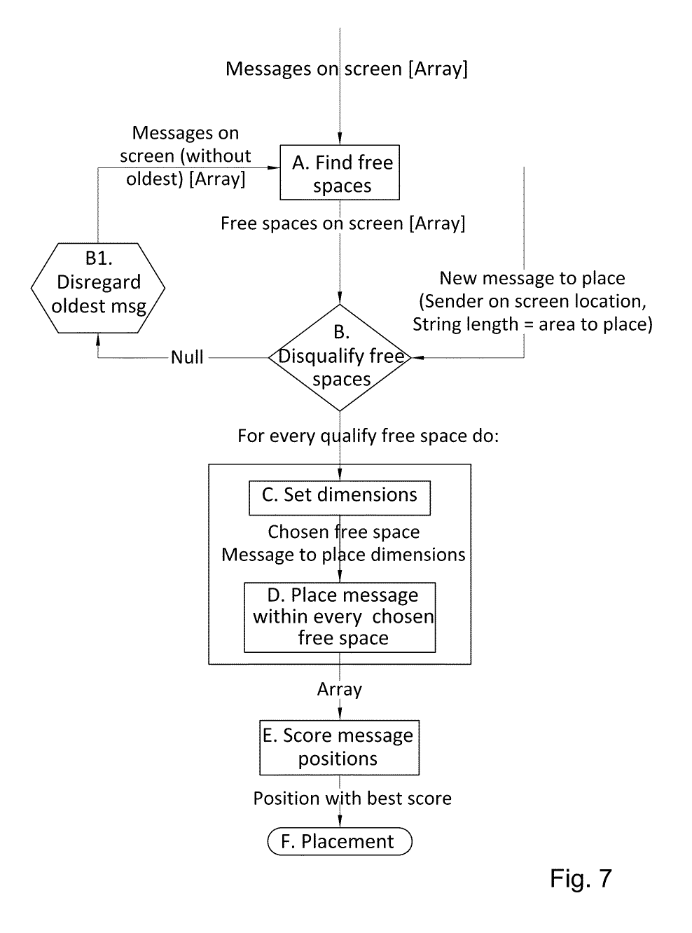

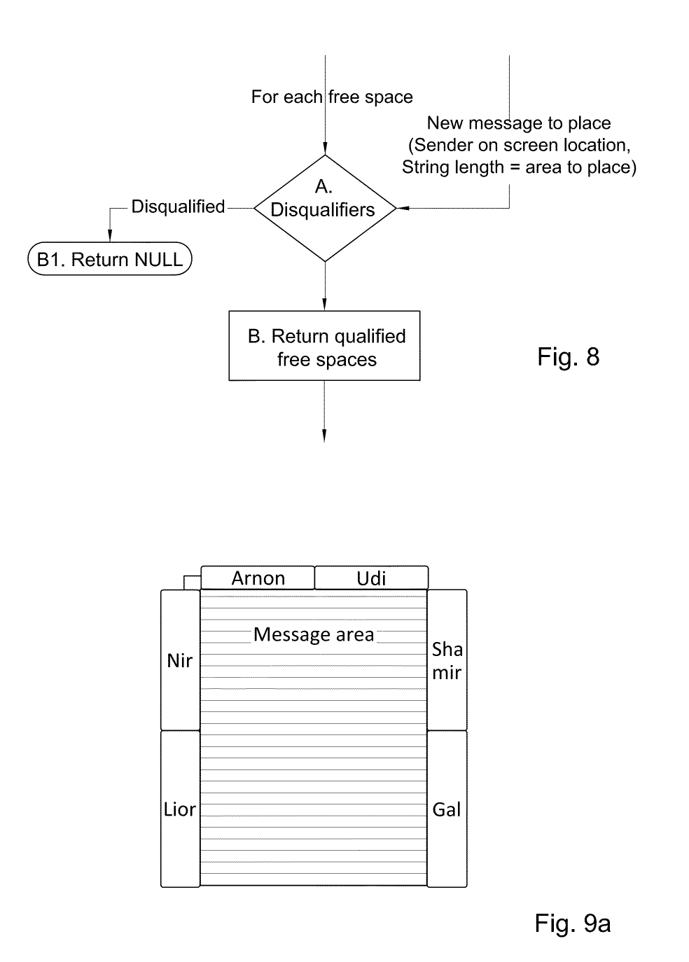

DIS_CENTER_WEIGHT=2. Reference is now made to the method of FIGS. 7 and 8. FIGS. 7 and 8 may be similar to FIGS. 4, 5 other than as described herein: Examples of Disqualifiers e.g. for use in step B of FIG. 7, are now described.

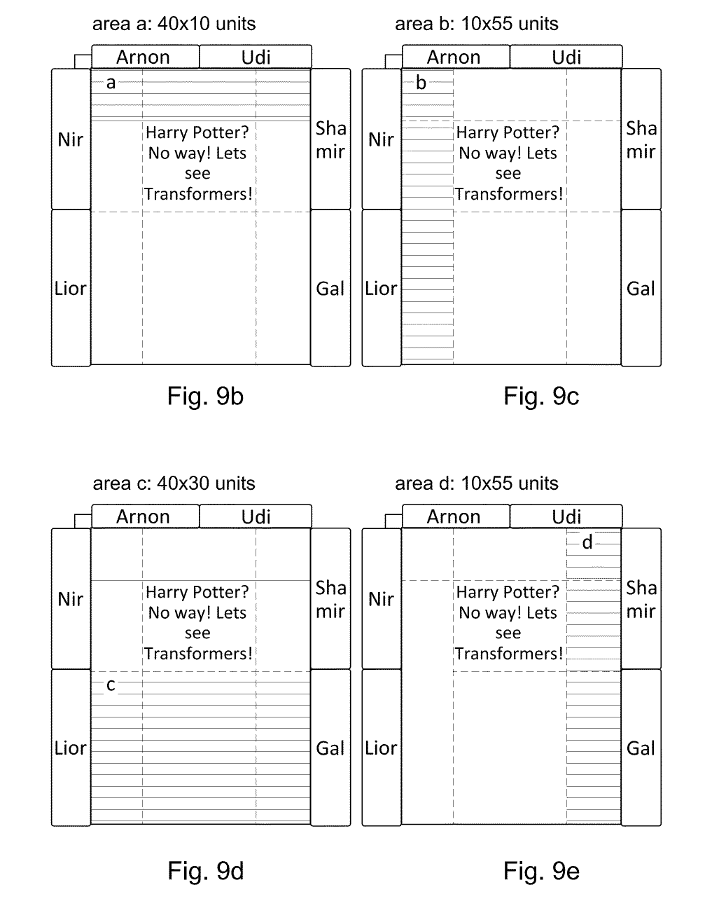

A screen before any message is entered, is shown in FIG. 9a.

Suppose one message is entered, then FIG. 7, step A. “find free spaces” may return the following areas a, b, c, d, whose size of area is indicated in FIGS. 9b, 9c, 9d and 9e respectively.

All height and width measurements below may be considered constants.

a (40×10): b(10×55):
c (40×30): d(10×55):

### Example 1

### Free Space is Too Small to Fit the New Message

Suppose the new message size is 900 (30×30 for example) then areas a, b and d may be disqualified due to their overall size.

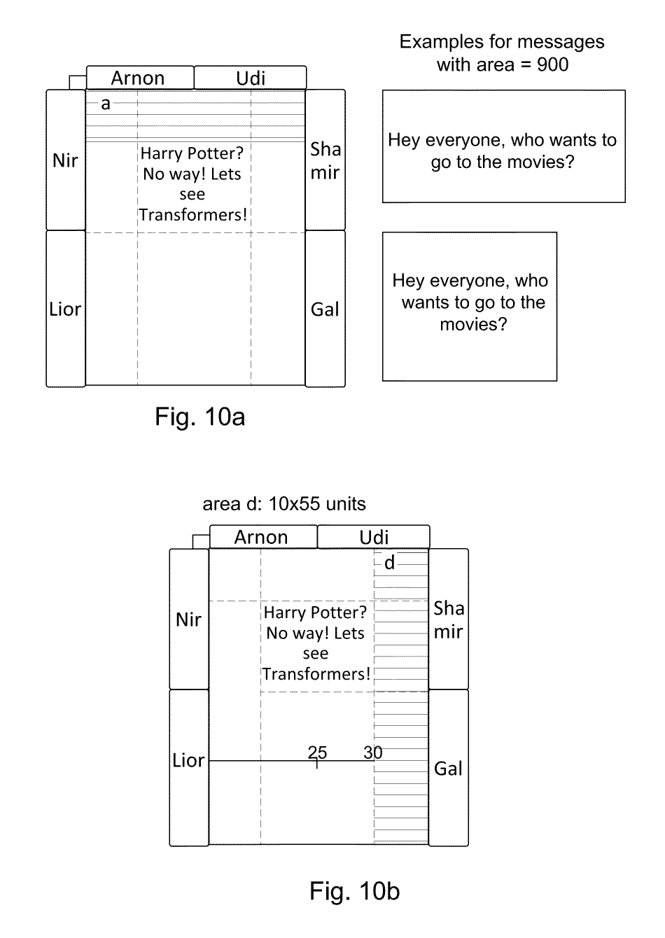

An example is shown in FIG. 10a.

The area ‘a’ is smaller than 900, therefore cannot accommodate the message with area 900.

### Example 2

### Free Space is Too Narrow

MIN_WIDTH is a parameter created to control the minimum width that message could be; if a free space is too narrow, it may be disqualified. For example if the MIN_WIDTH is set to be 15—the free spaces “b” (10×55) and “d” (10×55) in FIGS. 9c, 9e respectively may be disqualified.

### Example 3

### Disproportional height to width

Another parameter set—(HEIGHT_TO_WIDTH_MAX_PROPORTION) and the free space, may be in alignment with each other. For example if this parameter is set to be 2, then the height may be up to two times the width, and as may be seen in FIGS. 9c and 9d; the free spaces “b” and “d” may be disqualified.

### Example of Disqualifier 4

### Free Space is Too Low (not Enough Height)

As for the example disqualifier 2 above, MIN_HEIGHT is a parameter created to control the minimum height that a message box could be in. If a free space is too low (lower than the MIN_HEIGHT), it may be disqualified. For example, if the MIN_HEIGHT set to be 15, the free space “a” (40×10) may be disqualified).

### Example 5

Distance of free space from user location is too far. MAX_DIS_CHOOSE—another parameter, for example if the next message in FIG. 10b sent from the user, Lior, and MAX_DIS_CHOOSE is set to be 25, then space “d” may be disqualified due to its distance from the user, Lior (30). The purpose may be to avoid too much distance from the initiator of the message to the message e.g. as shown in FIG. 10b.

Referring Now to FIG. 7, Step E:

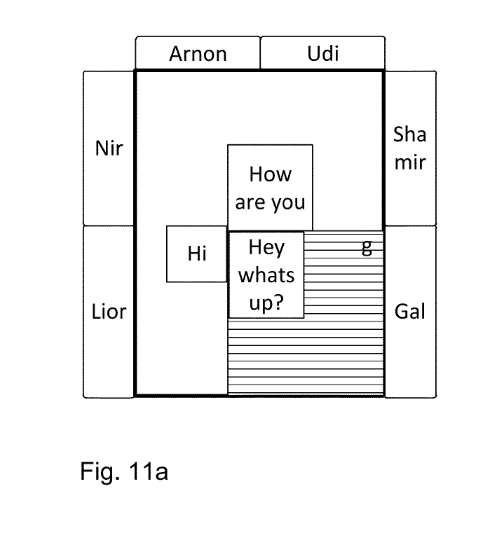

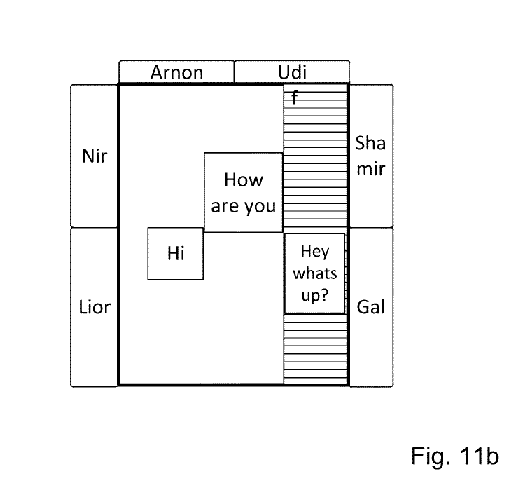

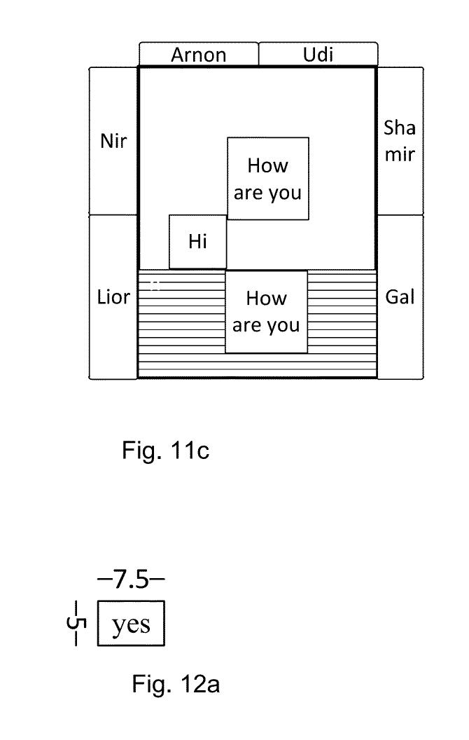

For Every Message Optional Position—
One example of computing the message positions score is: score=DIS_USER_WEIGHT*(dis_from_user)+DIS_CENTER_WEIGHT*dis_from_center, where:
DIS_USER_WEIGHT, DIS_CENTER_WEIGHT—coefficients assist in prioritizing the better option—a message that is closer to the center of the screen, or a message that is closer to the user.
dis_from_user, dis_from_center—parameters indicate the actual distance of message position from the user and from the center.
The coefficients are set a priori in the program by the programmer, but may be changed “on the fly”.
An example of performing step F of FIG. 7, including choosing a message position based at least partly on the score, is as follows, with reference to FIGS. 11a, 11b:
Assume that a message arrives from a user, Gal, after two messages already appear on the screen, the qualified spaces (g,f,h) and the message positions being as follows:
For example, assume that DIS_USER_WEIGHT=5 and DIS_CENTER_WEIGHT=1. Reference is now made to FIGS. 11a, 11b.

| In FIG. 11a: | In FIG. 11b: |
|---|---|
| dis_from_user = 21 | dis_from_user = 10 |
| dis_from_center = 9 | dis_from_center = 21 |
| score = 105 + 9 = 114 | score = 50 + 21 = 71 |

In FIG. 11c:
dis_from_user = 18
dis_from_center = 16
score = 90 + 16 = 106

In the above example, the option of FIG. 11a may have been chosen by the “score message positions” function and the message may have been placed as in the option of FIG. 11a. If the coefficients (DIS_USER_WEIGHT, DIS_CENTER_WEIGHT) had been changed, another result may have been received.

FIG. 7, Step c: Set Dimensions:

this illustrates one example of settings for the dimensions of a message. Other methods for setting dimensions are possible. For example, x,y—a fixed dimension—may be set for each number of chars in the message. For example, for a message with 20 chars, the following dimensions may be set:

x=20 pixels and y=20 pixels.

Typically, the “set dimensions” function operates only with qualified (non-disqualified) free spaces.

PREFER_WIDTH is a parameter that is set by the programmer and is set to be a suitable, easy-on-the-eye width a message may be seen on screen. Once this PREFER_WIDTH is set, all the dimensions of a message are determined by the message width (relatively to this PREFER_WIDTH).

MAX_WIDTH is the maximum width a message may be. This parameter is set by the programmer but cannot be wider than the width of the “message area” (Fig x).
If width (of text in one row)<PREFER_WIDTH then set this width and a one row height
If the message fits in PREFER_WIDTH, and the resulting height fits, then set
If free-space width <PREFER_WIDTH, then set the free-space width
If the width result exceeds MAX_WIDTH, then set MAX_WIDTH
   If Width (of Text in One Row)<PREFER_WIDTH then Set this Width and a One Row Height:

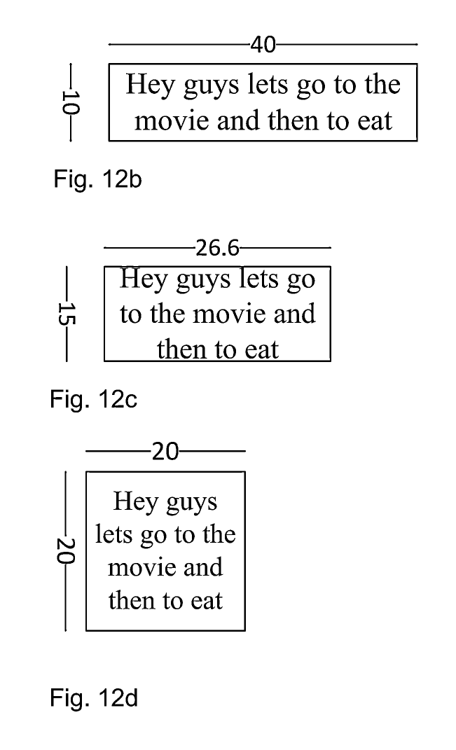

If the text of the message is very short and may fit the PREFER_WIDTH without taking up more than one row, then this may be the width of the message. For example, if the text is “yes” and PREFER_WIDTH=10 the message box may be as shown in FIG. 12a.

If the Message Fits into PREFER_WIDTH, and the Resulting Height Fits, then Set:

Assume the text of the message entered is: “Hey guys lets go to the movie and then to eat”, assuming that the area of this sentence is 400 pixels and assuming that the PREFER_WIDTH is set to be 40, the function may try to adjust the height of the text to fit the width of 40. The message box may be as shown in FIG. 12b.

If this message box is fit to enter in the chosen “free space”, suitable dimensions are set.

If Free-Space Width<PREFER_WIDTH, then Set the Free-Space Width:

If the free space is smaller than the PREFER_WIDTH the message typically has to be smaller than the PREFER_WIDTH. In such cases, the message width may be the widest setting possible (it will thus be the closest to the PREFER_WIDTH) and it is set to be the width of the free space, and the height of the message is set accordingly. For example, for the message: “Hey guys lets go to the movie and then to eat”, assuming that the area of this sentence is 400 pixels and assuming that the width of the free space is 26.6, the message box may be as shown in FIG. 12c.

If the Width Result Exceeds MAX_WIDTH, then Set MAX_WIDTH

In cases where a message box exceeds the MAX_WIDTH parameter, i.e. a message text cannot fit in the PREFER_WIDTH, and is wider than the PREFER_WIDTH in a specific free_space, then the MAX_WIDTH is set.

For example, assume size of the free space is width=100 height=20 and the PREFER_WIDTH=10, MAX_WIDTH=20 then the message box to the sentence: “Hey guys lets go to the movie and then to eat”, assuming that the area of this sentence is 400 pixels and may be as shown in FIG. 12d.

The ‘place message within free space’ process strives to enable the best way a message may appear on a screen. This is merely one example:

The ‘place message within free space’ process may comprise some or all of the following steps, suitably ordered e.g. as shown:
Choose placement method (opposite side of user location, for example: if user is on the left side then “how” far to right):
   If the ratio between is message area and free space area is too big (>MAX_WEIGHT_RATIO) then (Method_{—}4) third of the distance between the user and the center of the free space. (closer to user)
   Else if the free space gas beyond the center of the screen
      If the message fits up to the center then->(Method_{—}1) set in middle of the screen
      If doesn't fit->(Method_{—}2) at the center of the screen
   else->(Method_{—}3) at the center of the free space
Place as close as possible to the virtual line connecting between the sender and the center of the screen.
Shift in order to overlap older message (X_MARGIN, Y_MARGIN)
   Choose Placement Method (Opposite Side of User Location, for Example: if User is on the Left Side then “How” Far to Right):

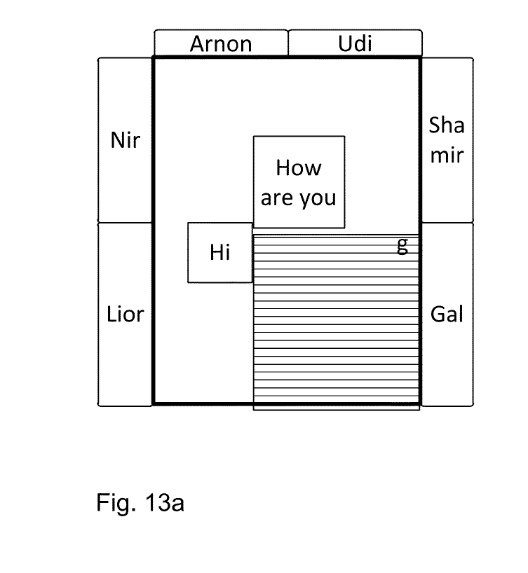

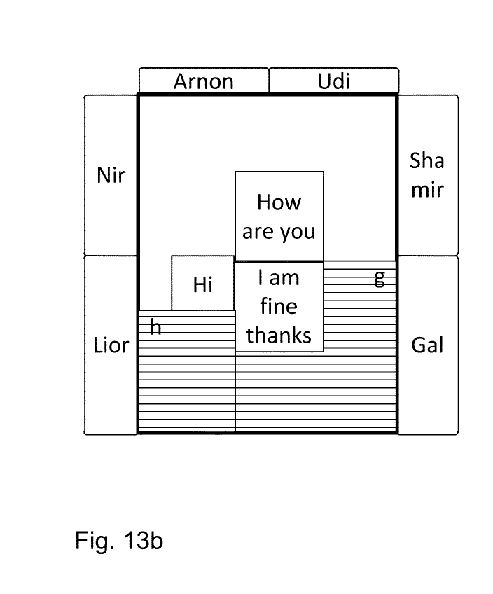

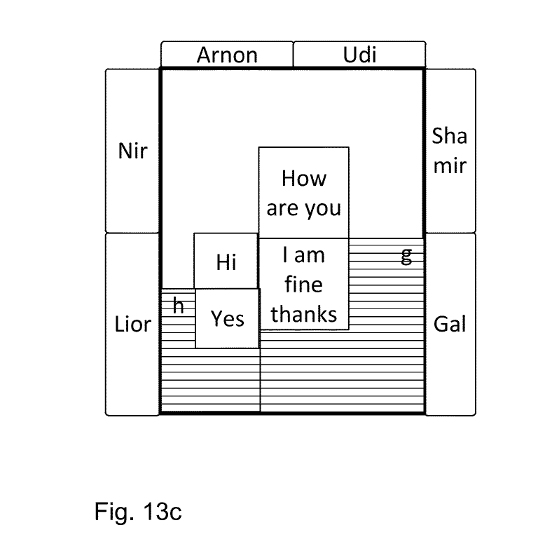

The ‘place message’ typically strives to place the message as far in the center as is possible from the user, within a chosen free space. This means that when a free space is chosen on which to place the message, the message may be placed as far away from the user up to the center of the screen, with the effect that the messages are placed from the center towards the user and always close to each other, as illustrated for example in FIG. 13a. When a user, Gal, enters a message and the free space “g” is examined, the process may seek to place the message to the left of “g” (“opposite side of the user location”) and the result may be as shown in FIG. 13b. Similarly, if user Lior enters a message (assume that the best position was in free space “h”) the method strives to enter the message in the right of “h” (“opposite side of the user location”) since user Lior is to the left of the “message area”. The result may be as shown in FIG. 13c.

FIG. 6b, step 659: If the ratio between the message area and the free space area is too large (>MAX_WEIGHT_RATIO) then (Method_{—}4) utilize one-third of the distance between the user and the center of the free space (closer to the avatar).

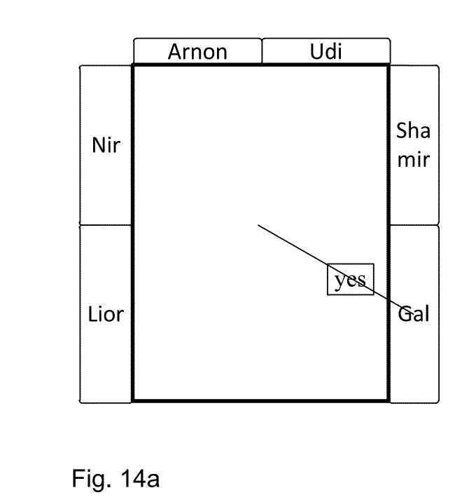

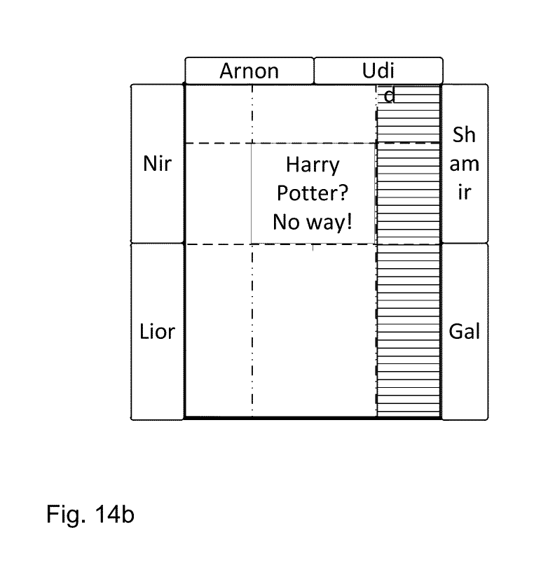

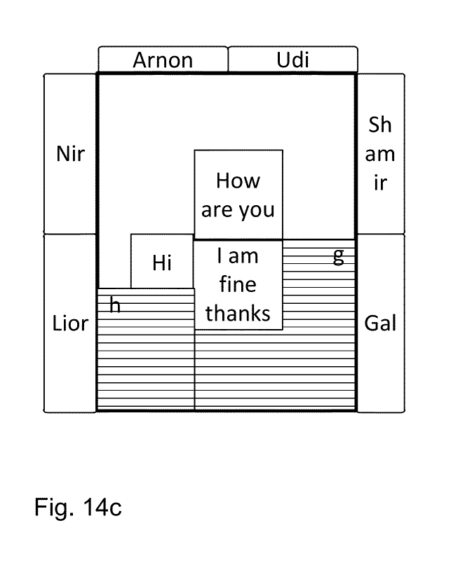

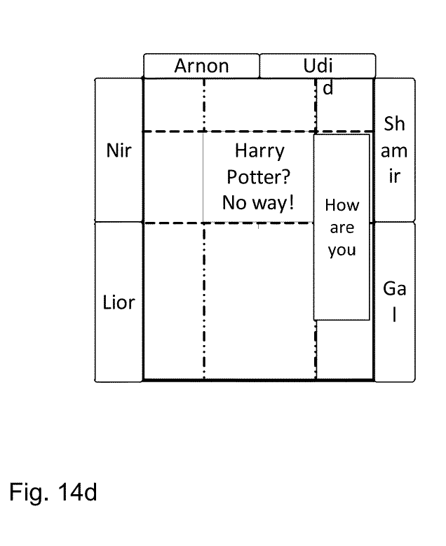

Consider a situation where a short message is to be placed in a large free space (a parameter determines the ratio between message length and free space size which thresholds the definition of such situations). In such cases, the message may be placed at a distance from the avatar, which is one-third (selectable parameter) of the distance between the avatar and the center, but this “third” is a parameter and is subject to change. For example, if the MAX_WEIGHT_RATIO is set to be 30 and the free space area is 2200 and the message area=50, then this rule be effected as in FIG. 14a, showing a message from the user, Gal.

FIG. 6b, step 660: If the free space goes beyond the center of the screen

If the Message Fits Up to the Center then is->(Method_{—}1) Set in Middle of Free Space?
If the free spaces exceeded the center of the screen, for example when user Gal is placing a message, the free space “d” extends beyond the center e.g. as shown in FIG. 14b.
For example the free space “h” in FIG. 14c does not go beyond the center of the screen (its width<½ screen width and height<½ screen height and its left bottom corner is aligned with the left bottom corner of the screen) e.g. as shown in FIG. 14c.
In such cases, if a message is sufficiently large to fit up to the center of the screen, it may be placed in the center of the free space “d” e.g. as shown in FIG. 14d.

Because the message “How are you” is higher than the height between the bottom of “d” up to the middle of “d” (which is the middle of the screen in this example), the message is placed in the center of “d”.

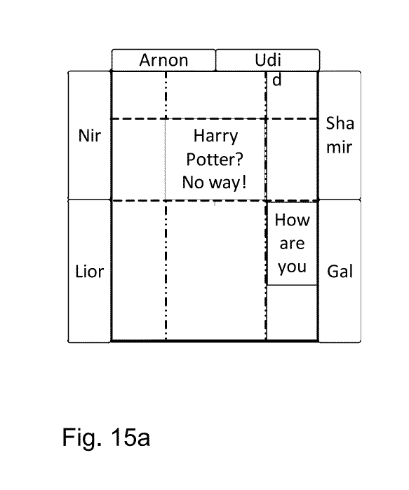

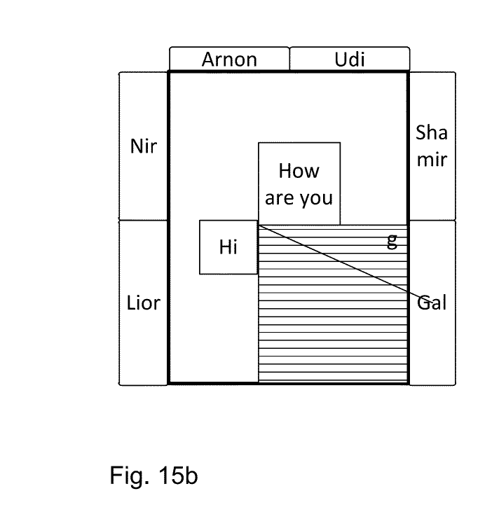

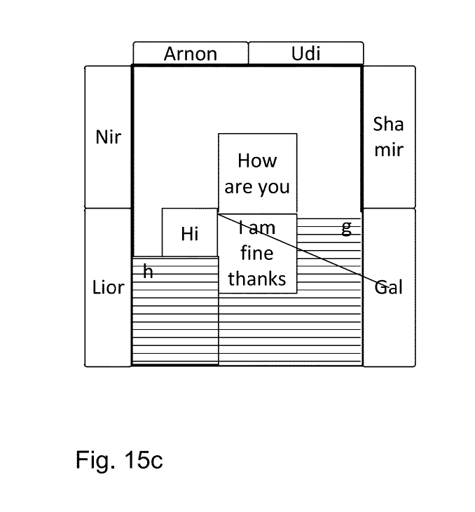

If does not Fit->(Method_{—}2) at the Center of the Screen
If the message is not sufficiently high to fit up to the middle of the screen it may be placed near to the center, as may be seen in FIG. 15a.
   FIG. 6b, Step 670: Else->(Method_{—}3) at the Center of the Free Space
If the ratio does not exceed MAX_WEIGHT_RATIO and the free space does not exceed the center of the screen, then the message is placed in the center of the free space.

Referring again to FIG. 6a, step 650 may comprise: Placement as close as possible to the virtual line connecting between the sender and the center of the screen. Specifically, for each avatar there is a line connecting the avatar to the middle. The method strives to position each message in the specific free space as close as possible to this line. This results in messages which are perceived to extend from the center of the “message area” towards the avatar, e.g. as illustrated in FIG. 15b.

When user Gal places his message, apart from the consideration that, typically, the message may be as far to the left as possible in the free space, the message may also be as close as possible to the connecting line e.g. as illustrated in FIG. 15b. Therefore, the message box is placed near the up-left corner of the free space “g” e.g. as shown in FIG. 15c.

FIG. 6a, step 630: Shift in order to overlap older message (X_MARGIN, Y_MARGIN):

In order to visually indicate which messages are older ones, newer messages may overlap older ones. The X_MARGIN and Y_MARGIN may be a priori set by the programmer and may be no more than a few pixels of the screen. Examples for overlapping:

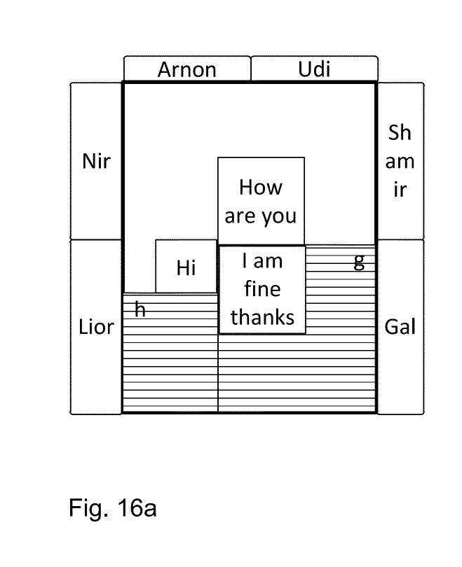

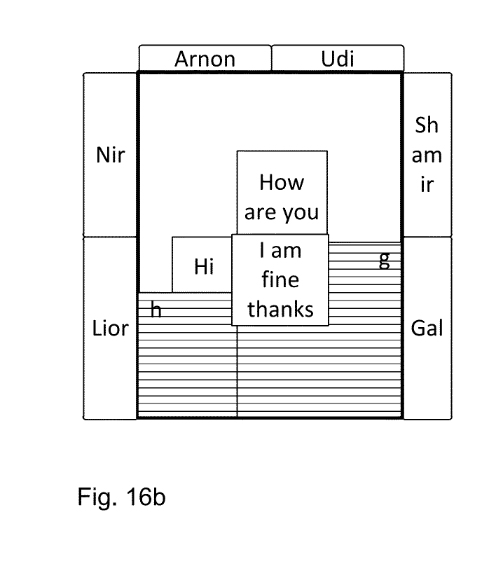

Before the shift is shown in FIG. 16a.
After the shift: (assume a few pixels of X_MARGIN and Y_MARGIN) is shown in FIG. 16b.

An example of a suitable data base structure serving the systems and methods shown and described herein, is now presented:

The structure of the data base in the client and the server may be similar, except that the server typically holds this structure for each user it serves. A particular advantage of the structure of the data base described herein is support of the flexibility and multiple “actions” of systems e.g. as described herein.

A chat room (e.g. conversation, discussion) typically includes users and action, where a user may carry out specific actions in a room, like creating a text message or creating a room. Typically, actions exist on a time scale. An action may comprise anything from a text message to live video. Actions may also include the following:
Adding a user
Removing a user
Sounds
Visual effects
An action may not be visual, as in the case of ‘add user’. The server is typically responsible for synchronizing clients with the most recent actions in a room, and for broadcasting actions from a client to clients, or from a server to clients.

Desired flexibility typically includes the ability to add and create custom actions that are not yet known to the database, without departing from the database structure or the client's data. The structure shown and described herein supports the ability of developers to add new types of actions to the system without changing the data base and also supports features that are shown herein (e.g “direct message”, “quick poll”, sub-groups etc. . . . ). For example, if a certain type of action that the user may do is write a regular message and send a picture, after a minor update of the software (adding metadata to the protocol), the user is able to direct his messages towards sub-groups and the same database is able to support this action.

Furthermore, if for instance a system is deployed with the ability to handle text messages, and further adding a new action type ‘v’ for video bubble is desired, this may be done by rapidly updating the client code with a ‘version’. The server side stays intact, and video bubbles may then be navigated.

In this way, many message types (such as but not limited to: send message to sub-groups within a group, create a direct message, create “quick poll” message, picture, voice, video, location) may be implemented, and this structure allows efficiently adding a large variety of types of action in the future.

The design of the database structure typically enables the server and clients to play back actions online or offline. Clients may thus view actions as they happened over time, just as one may view a movie.

The client may typically pause, move forward or backwards in the timeline, and focus on actions that are of interest to him.

The server is typically operative to streamline (sync) the actions to the clients, and this is typically done in some or all of the following distinct cases:
1) When a client enters a ‘room’, the server sends the client the most recent N actions.
2) When a client creates an action, such as a text bubble, the server broadcasts the action.
3) When a client navigates history within a room.
4) When a client initiates an action to be injected to the room timeline, such as creating a room, the server broadcasts an ‘add users’ action.

When creating a room or entering into a room, the same methodology, mutatis mutandis, may be used. Client and server may be synchronized, by using sync action messages from and to the server.

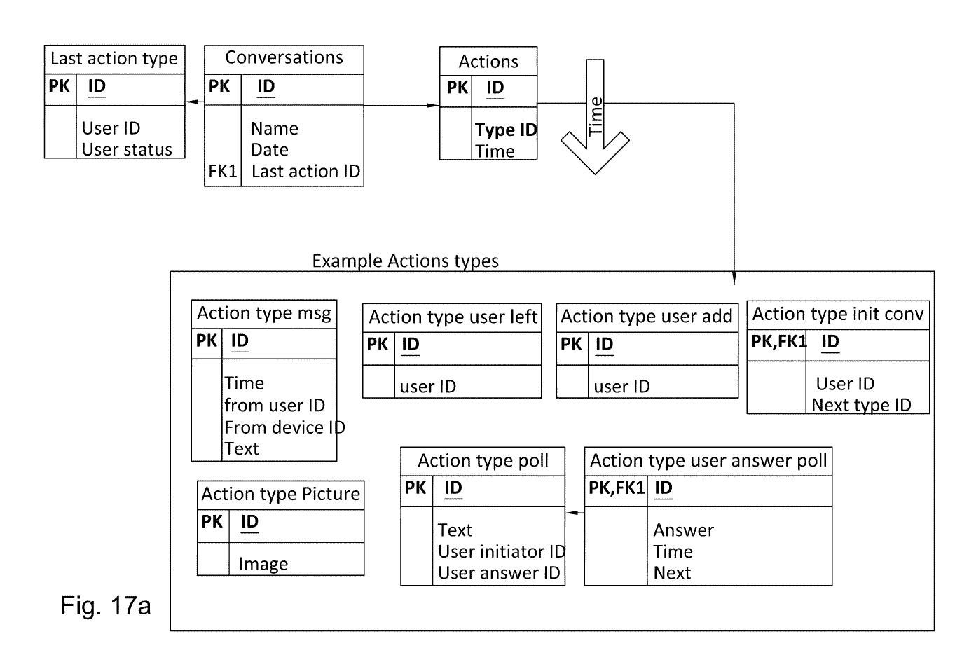

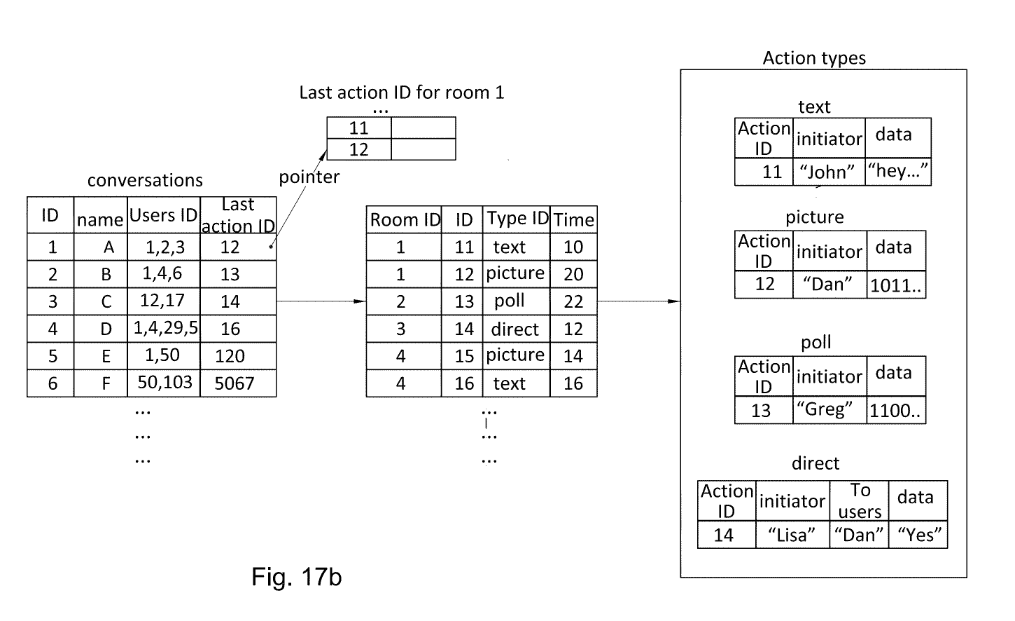

Referring now to FIG. 17a, the database comprises a table of rooms (rooms, conversations and discussions refer to the same entity) (or several of them), each table being linked to an actions list table. The actions list table may be a table that describes the actions according to the table of rooms. Each action has one or more of: a unique ID, type, index and room association. Each action (row in the actions list table) may be linked to an action type table as shown that typically holds the data for all the actions of the type (e.g. by unique action ID).

For example, considering two rooms with ID 1 and 2, and in each room two actions were conducted, the action list may comprise four rows with actions with the unique IDs 1, 2, 3, 4, where each row in this table has the room ID (the rooms in which the actions were conducted) and the type ID. Suppose action number 1 was “text message” so it has the “text” type ID. Then in the action type table from the type “text message” a row may be written with all the data that comprise the message, with the unique ID number of the action. Thus it may be seen that in room number 1 an action was conducted, and that the action was “text message” with the data being shown in the “text message” table.

Furthermore, the rooms table also typically holds the last action index of a room, this index being sequential and starting from 1 upwards The table of the rooms is connected to the action table by the “last action ID” such that in each state the last action ID is indicated and is linked to its row in the action table.

The database has pre-set tables for common action data types, such as:

action_text—for plain messages.
action_int—for plain integers.
action_status—for user status states.

The structure of the database typically allows addition of any new type of action by inserting a new action table type.

Example tables are shown in FIG. 17b._As may be seen in the example, the table of rooms comprises room IDs. Each room may be a row in the database that holds the data related to this room. In the illustrated example, the data saved is some or all of: the room ID, name, user's ID (that is in this room) and the last action ID (that was in sync with the server). The program displays the last action ID on the screen. As described in the “top” view, the last action ID typically connects to a table that holds, in sequential order, the message ID of each room (e.g. “last action ID for room X”).

The display of the room may be set by the data in the conversation table, the action table and the action type table.

List of action types: Action types may include a text message, direct message, private message, picture, video, quick poll, voice message, create conversation, status, mood, add user, typing, receive message etc.

______An example flow of an action initiated by the user is now described.

An example, named type ‘t’, considers a scenario where a user types a text bubble in a room:
1) A client types text in a room.
2) The client sends a sync message to the server.
3) The server adds the sync action message to the actions list table under the room, flagging the action as type ‘t’.
4) The server updates the actions_text table with the action data.
5) The server broadcasts the action to all of the clients (including the sender).
6) A client gets a sync action message, and only then it inserts the data to his local database, doing so by executing a similar logic to that of the server.
   The outcome of this is typically a mirror image of the client and server data.
   However, consider the case of a client returning to a room that he has not visited for some time. In such cases, the client has missed some actions, N in number, and, upon entering the room again, the server updates the client with the last N−M, sync action messages.
   In this case, the client typically tells the server the last action index in a specific room as he knows it, and/or the maximum number of visual actions that he wants.
   The server fetches the last M sync action messages, from the database or from the cache.
   Actions may not be visible, they may be implemented in logic, so when the server needs to fetch the last M (Visual Actions) it may do so by iterating backwards from the last action in the room to the last client action in the room. It typically finds visual actions along the way, and stops when it reaches the start index (1) or when the maximum number of visual actions has been collected.

An example server side protocol and architecture are now described. The server may comprise a socket based server that listens on a predetermined ip and port, for incoming clients. When a new client arrives, the server checks that the client is a recognized client, and adds his ip, to a list of in memory clients, and opens a dedicated socket for the new client.

From now on, all communication between the server and the client typically takes place on the dedicated full duplex TCP socket.

Server functionalities may include some or all of those described below.

Registration, according to some embodiments, is now described, however the implementation below is not intended to be limiting.
The first step for a client type, before anything can take place, is to register with the server.
The client identification is his personal unique identifier GUID which he passes along with all of the server API calls.
   The mobile application checks to see if he already registered against the server, and if not, generates a unique identifier GUID and stores it in a safe place.
   The mobile user is asked to fill in his phone number, or email address, name and address, and the details are sent to the server alongside the mobile identification GUID and other mobile details.
   The mobile application enters a confirmation code screen and waits for the server to send back a confirmation code, by SMS, in the application itself that the user, typically, must enter.
   The server processes the registration, stores data in his data base, and sends back a confirmation code.
   Upon entering the confirmation code and sending it back to the server, the device is registered and authenticated.
      A user may have several devices attached to him.
      A device may be active or inactive so scenarios such as a lost device or stolen device may be solved.
      If the client unique identifier is tampered with, changed or removed by any means, then the client is considered as not registered. In such cases, the client may generate a new unique identifier GUID and re-register.
      If the client passes the first initial “is registered” check against the server and later on the server detects that the unique identifier of the client is no longer registered, in scenarios of tampering after the first registration, then the client may stop whatever he is doing and force the user to register the device again.

An example of a suitable client registration flow is illustrated in FIG. 19a.

Version Control, according to some embodiments, is now described, however the implementation below is not intended to be limiting.

The server holds an application version number, during the process of checking if the client device is registered (as described in 1); the client passes along his version number, so the server knows what is the up-to-date version number of each client that it has.

When the application is downloaded, from the app store or the marketplace or any other service for application download, his version number is embedded inside the binary image.

Upon first launch of the application, the inner version number is saved to a place on the flash of the device that can be written to.

If the client version number is less than the server number, then the client may be prompted to upgrade to a newer version and the application may exit.
For other scenarios such as informing the client that a new version is available but he may continue to work if he wants to, there are other mechanisms such as 5—Notifications.

Groups, according to some embodiments, are now described, however the implementation below is not intended to be limiting.

A group is a collection of users from which the user may start a conversation. It is a template for building the conversation, and not the conversation itself.

The server stores the groups of a client, so when a client migrates to another device, they may be restored.

The groups may be formed in any suitable manner on the client side such as but not limited to: trying to match phone numbers or email addresses of potential users that the client has on his phone contacts list, or by the user selecting group members from a list, or by taking groups that are already in use by the user somewhere else on the device (favorites or Facebook for example)

The client parses the device contacts lists and sends it to the server to try to find a match with known users. This operation is costly so it may be done only once, when no client cache exists. Results may be cached on the client itself, and further server round trips may pass only the deltas.

A user may have multiple devices with multiple contacts lists so it is possible that the groups that may be generated on each device differ. The groups may be kept per device.

The query that the client uses may be part of the 7—General Queries and may be put on a different database.

Conversations, according to some embodiments, are now described, however the implementation below is not intended to be limiting.

Each client (device) may take part in many conversations, of up to N clients, that are part of a group chat conversation.

Each participant (client) is identified by his device unique identifier.

The initiator of the conversation is the one that started the conversation from a given group template, and he is the first to write a message. By sending it to the server a new conversation is started, and all of the online participants get the conversation added to their conversations list.

Although there may be only a maximum of N users in a conversation, the client (initiator) may add users to a conversation on the fly.

Push Notifications, according to some embodiments, are now described, however the implementation below is not intended to be limiting.

For those clients that are part of the conversation but are offline (not connected) the server pushes the messages of the conversation via Apple push, or other appropriate technologies on other mobile platforms.

Part of the client (device) initialization flow is to try to register with Apple push services and get a push token back. Upon getting the token back, the device sends the token to the server and the server stores it in the database.

A server side push may be nothing more than a JSon request that is made to a dedicated APNS server.

The server may listen to the APNS feedback service which sends problems of push notifications that were not successful, and try to push only to the device that reports that it is ok to do so. Failing to do so may block the server from using Apple push, which is all part of the APNS quality of service.

Notifications Flow, according to some embodiments, is now described, however the implementation below is not intended to be limiting.
The server is typically responsible to send different kind of notifications that are more general and not part of a conversation, such as:
   Update messages that notify the user about a new version but does not exit the application.
   System messages.
   A conversation added.
   A conversation removed.
   Number of messages in conversations, so as to show the user badges of unread messages in his conversations.
      The client may poll periodically

General Queries, according to some embodiments, are now described, however the implementation below is not intended to be limiting.

The server may allow a client to query for a general action such as:
Are there any other users on the contacts list
Search a user

Permissions, according to some embodiments, are now described, however the implementation below is not intended to be limiting.

A user has permissions and it is the responsibility of the server to block users who try to call server side API's that they do not have sufficient privileges for, for instance:

Adding a user—an action that may only be done by a conversation initiator.
1. Ping, according to some embodiments, is now described, however the implementation below is not intended to be limiting.

The server is typically responsible to ping its clients, once in N seconds, to take care of ‘ungraceful’ client disconnections.

If a client does not respond to a ping, his socket is forcefully closed.

If a client was not gracefully closed, but the server has not yet detected this, and a re-connect request from him is received, reuse the socket and proceed.

An example protocol is now described.

As described herein all of the communication between a client and a server typically takes place on a full duplex TCP socket.

Each packet typically comprises a packet header and is followed by the packet data. The packet as a whole is a Unicode bytes array, so each Unicode char takes 2 bytes.

The packet e.g. as described herein may form the basic communication entity that carries information between the server and the client. It is not mandatory that a packet may contain data (ping packet for example). The packet entity is typically one level above the action types, meaning that the actions are one type of packet, and in a packet, from the type of action, the data may carry which action is performed (text message, direct message, picture, poll etc. . . . ).

A general packet is shown, by way of example, in FIG. 19b. Each illustrated cell is Unicode char, 2 bytes long).

The packet theoretically may be larger or smaller than the above example (if it has more or less data bytes)
The first portion of the packet is the packet identifier to confirm that this is a message and not just random data.
   It is 8 bytes long because the chars are Unicode encoded.
   This part never changes.
The second portion (0044 above) is the sum of the lengths of the packet identifier+the length of the length attribute itself+the length of the actual data including metadata.
   The length value is in bytes so there is a limit of 9999 bytes per packet.
   In the current example the length is:
   4 Unicode chars=8 bytes for the message identifier+
   4 Unicode chars=8 bytes for the message length itself+
   5 Unicode chars=10 bytes for the message type (M0210 in FIG. 19b)+
   5 Unicode chars=10 bytes for the string data field (S001A in FIG. 19b)+
   4 Unicode chars=8 bytes for the integer data field (1017 in FIG. 19b) Which adds up to: 22 Unicode chars=44 bytes (second portion).
The third portion (M0210 above) is the packet ID, that always starts with an “M” followed by the length of the ID (in Unicode chars) and then the ID itself in Unicode string.
   In the example, the message ID length is 02 Unicode chars and the ID itself is “10”.
After this, the packet ID is 2 unicode chars and indicates the data type (or action type) (e.g. 71 in FIG. 19b which indicate it is a MSG_SYNC_CHAT_ACT by the protocol)
Then the packet data may be written e.g. to also include the action type. A message usually has data but this is not mandatory. If the packet has data than the first, say, 6 bytes (3 unicode chars) may indicate the length of the data type and then the data type itself in Unicode string
   In the current example, a string data type is provided, which always starts with an “S”, of a length of 1 Unicode chars and having a value “A” which indicates a “direct message” type of action.
   The maximum length of a string type is 999 Unicode chars.

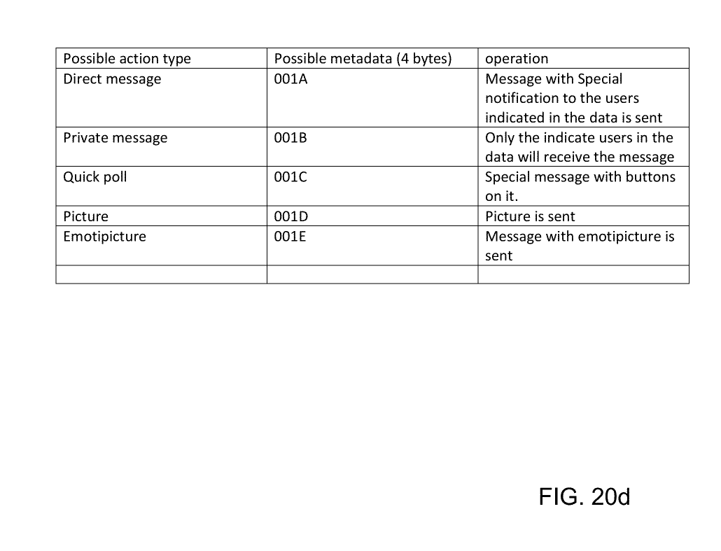

The table of FIGS. 20a-20e, taken together, illustrate packets, some or all of which may be implemented.

The parameters portion of each packet, which may be implemented wholly or in any suitable part, includes the suggestion to the actual data including metadata that comes after the message ID as described before. Each packet typically starts with a packet identifier followed by the packet length field.

The following are used as abbreviations: I (Integer), S (String) for the parameter types.

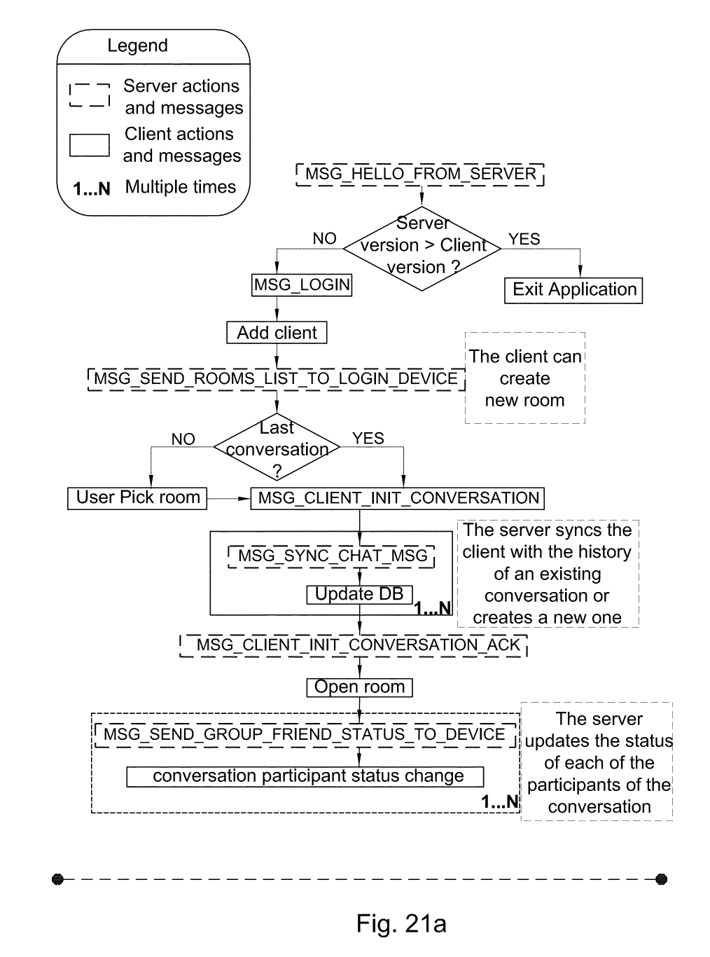

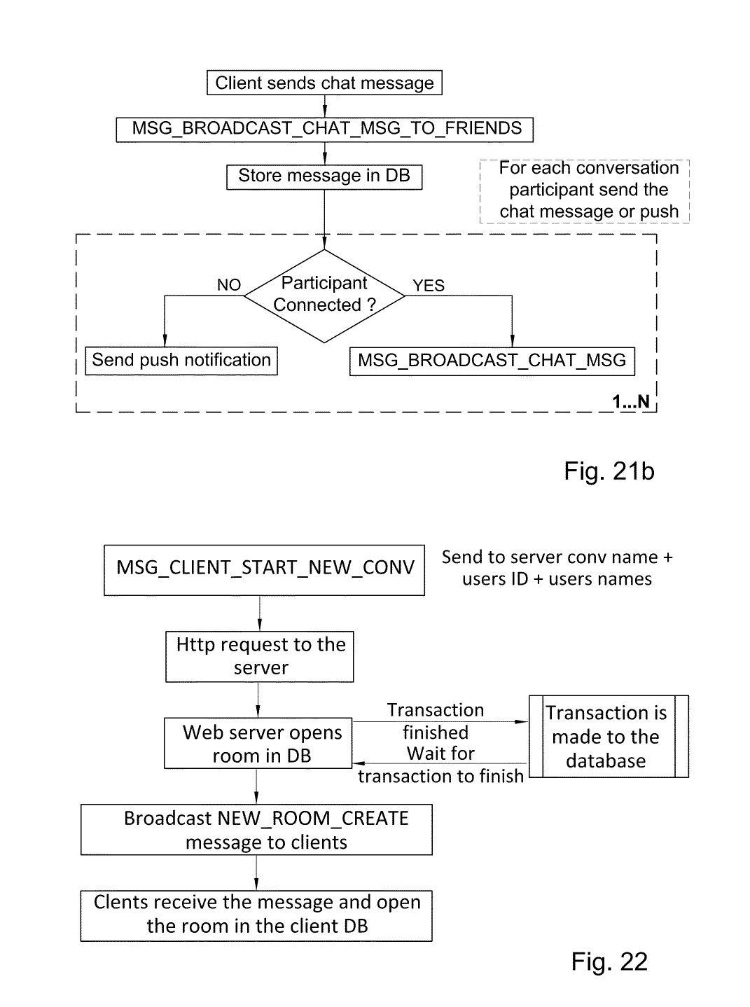

FIG. 21a is an example of a client server interaction diagram however it is appreciated that functionalities may alternatively be assigned to one or another of the server and client in any desired manner.

A conventional push scheme which may be employed is illustrated in FIG. 21b.

FIG. 22 is a simplified flowchart of an example method for new conversation creation.

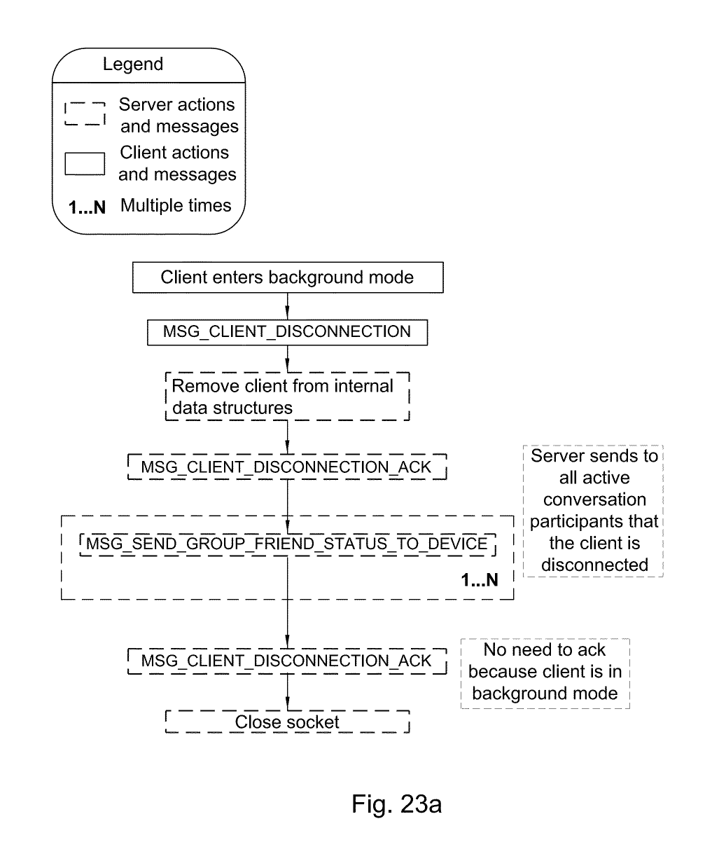

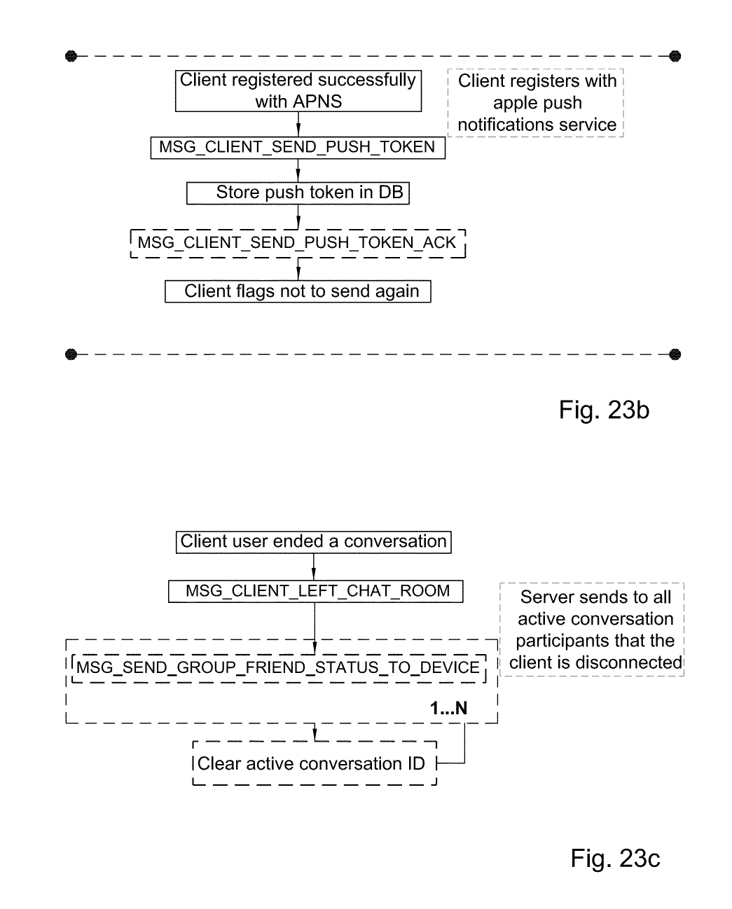

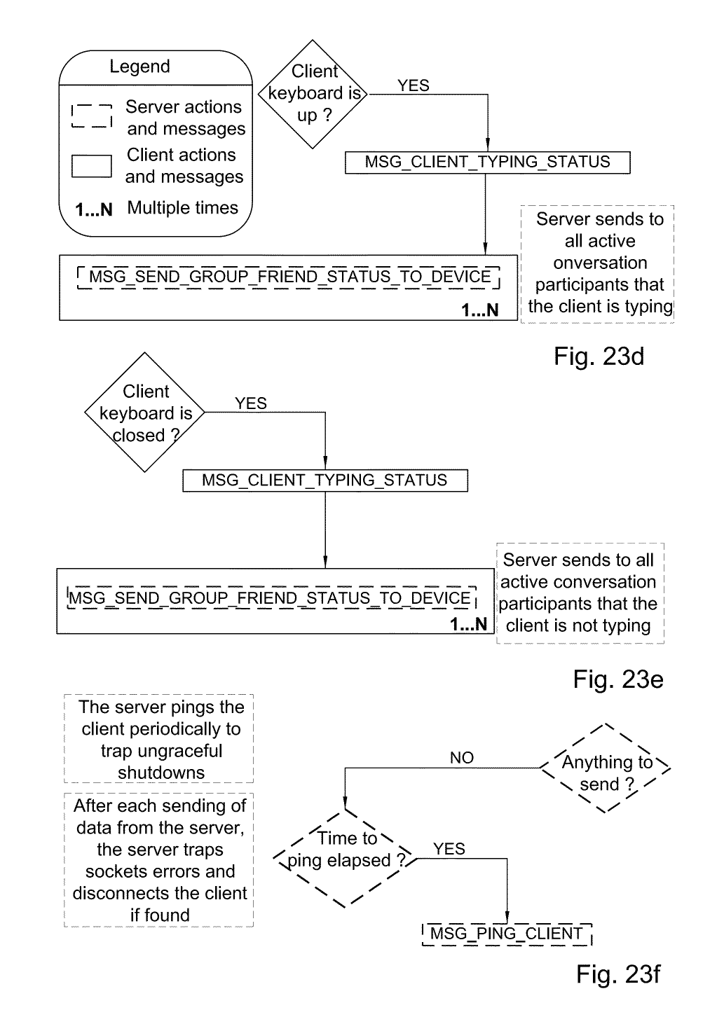

Possible client and server actions and messages and possible sequences thereof are illustrated in FIGS. 23a-23f.

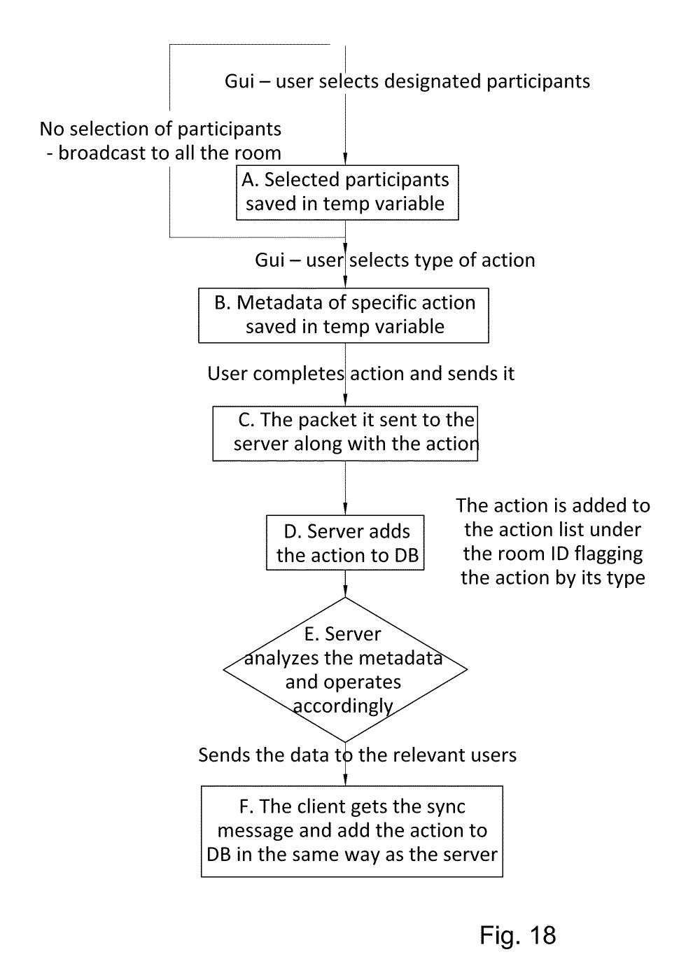

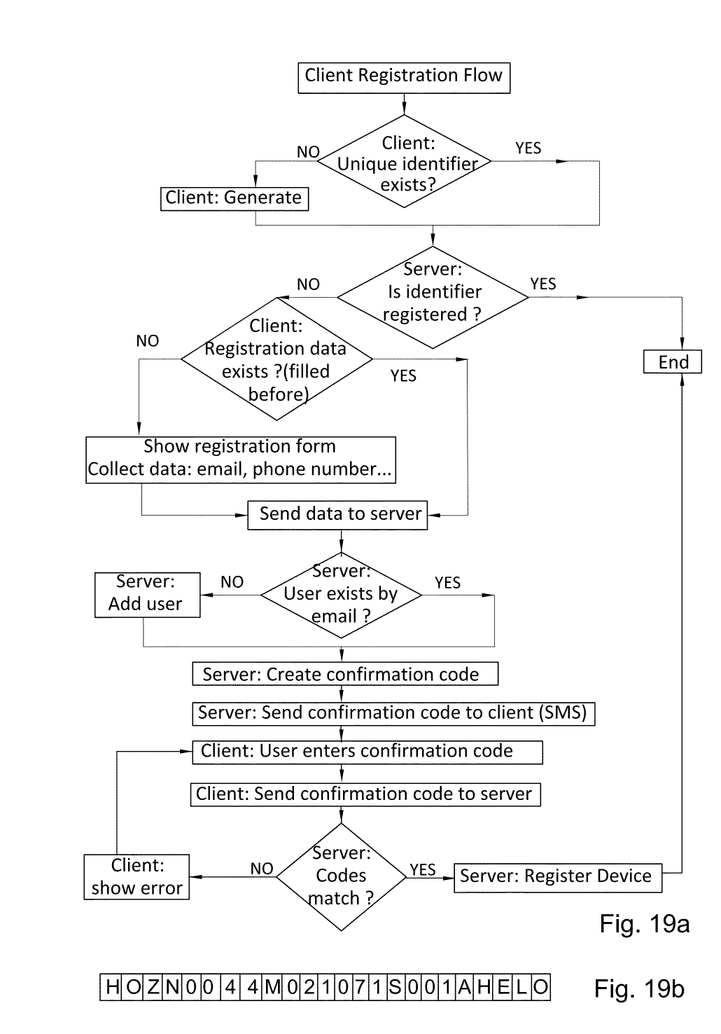

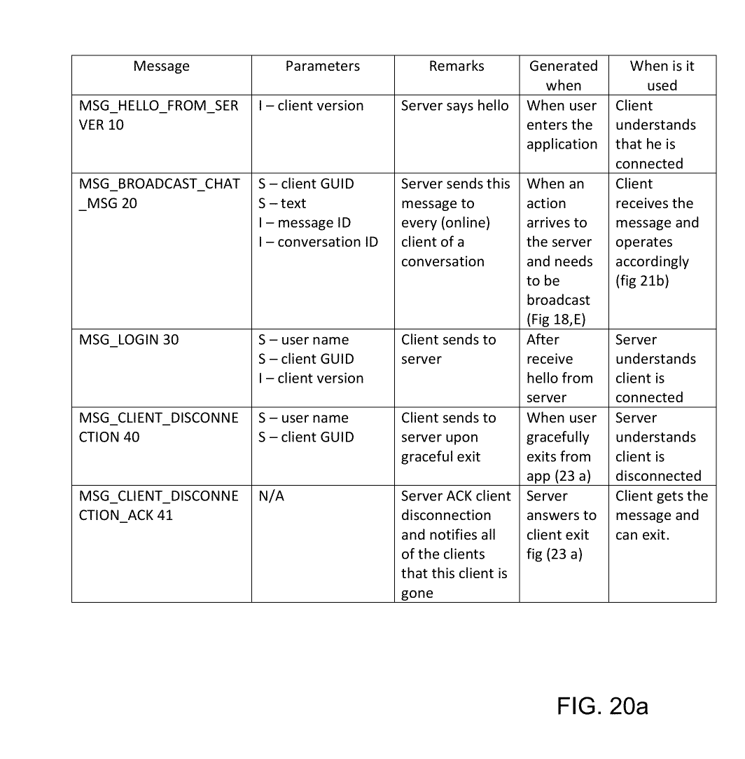

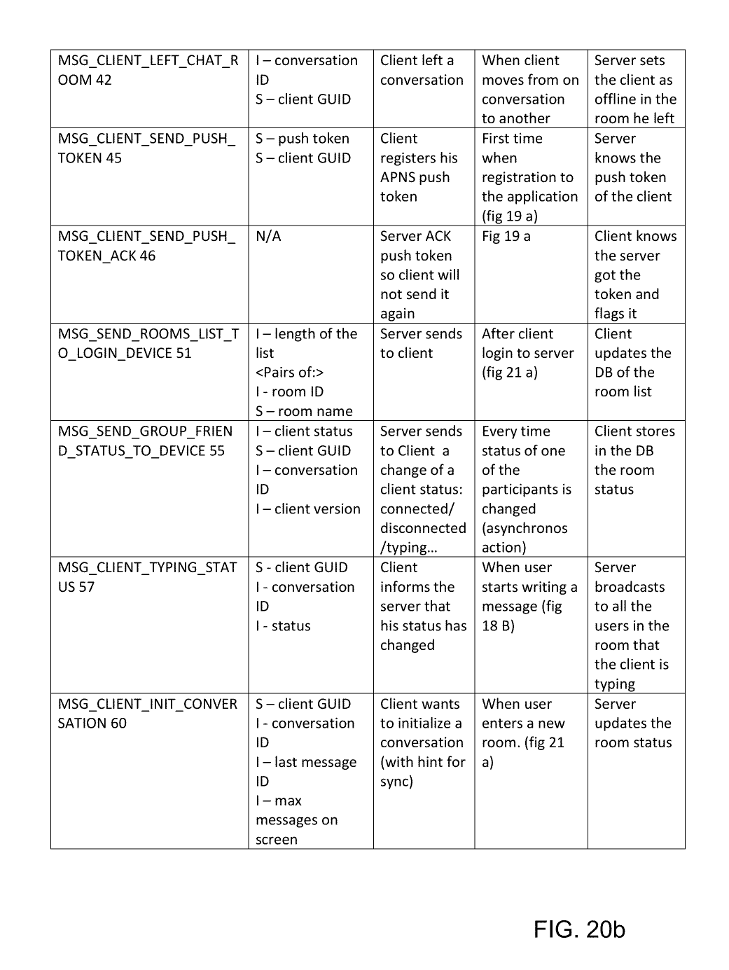

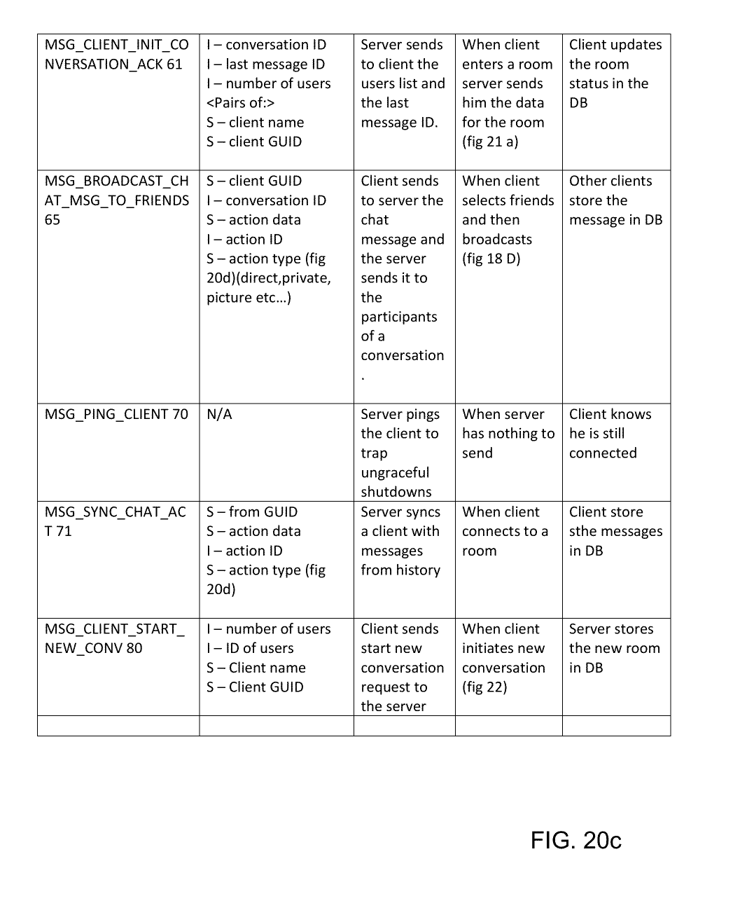

Reference is now made again to FIG. 18. For the purposes of description thereof, the following definitions may be employed:

An action is defined as any type of broadcast or non-broadcast message that is initiated by the user or the server and sent to participants in the conversation. Examples for actions that are initiated by a user are a message, private message, direct message, quick poll message, picture message, video message, user created new room etc.

Certain types of actions may be sent by the client or server without a user's control. Such actions usually comprise data about the users in the conversation or about the room status. Such actions may be status of the users (online, offline, typing), status on messages (for example—who read the message), location in space and surroundings of the users (Tel Aviv, New York etc. . . . ), mood (happy, sad . . . ), status about the room (e.g. number of users, user was added to the room, user left the room etc.).

As above, FIG. 18 describes an example “life circle” flow of an action that has been initiated by a user. Direct message feature is one such example.

Direct message is an action that is initiated by the user. When the user sends this message, it may be sent to all participants in the conversation, but only the participants the user selected may get special notification (e.g. sound, appearance, special indication). One option of the flow of the directed message is as shown in FIG. 18.

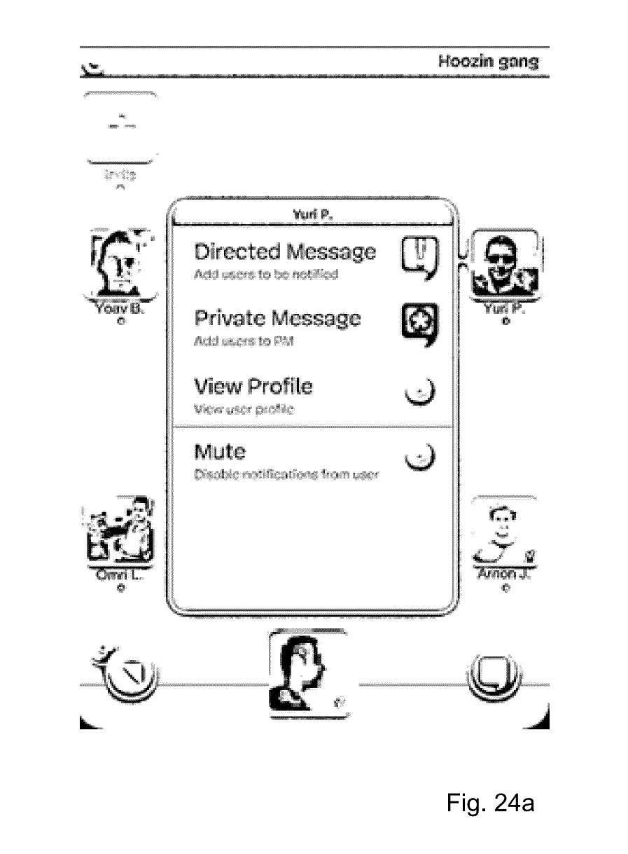

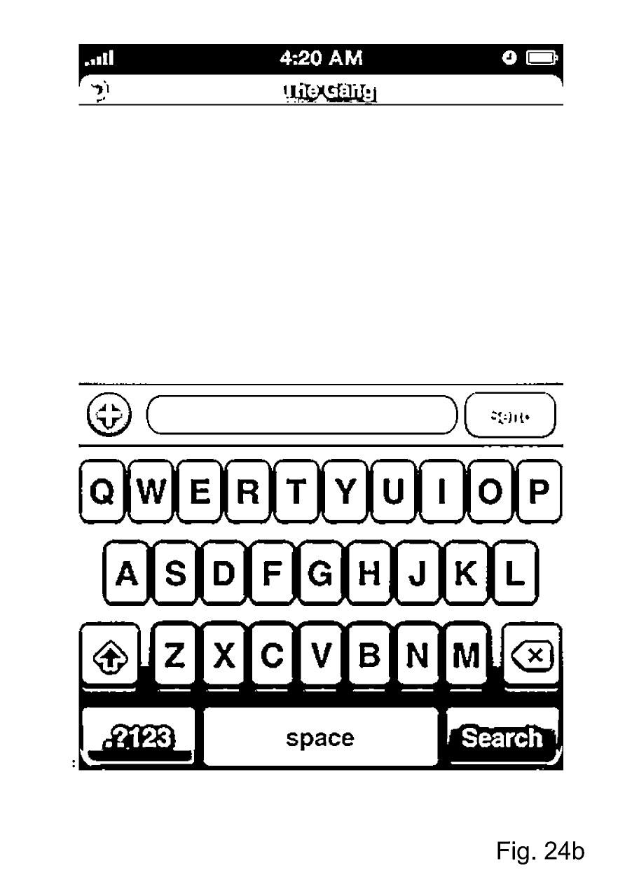

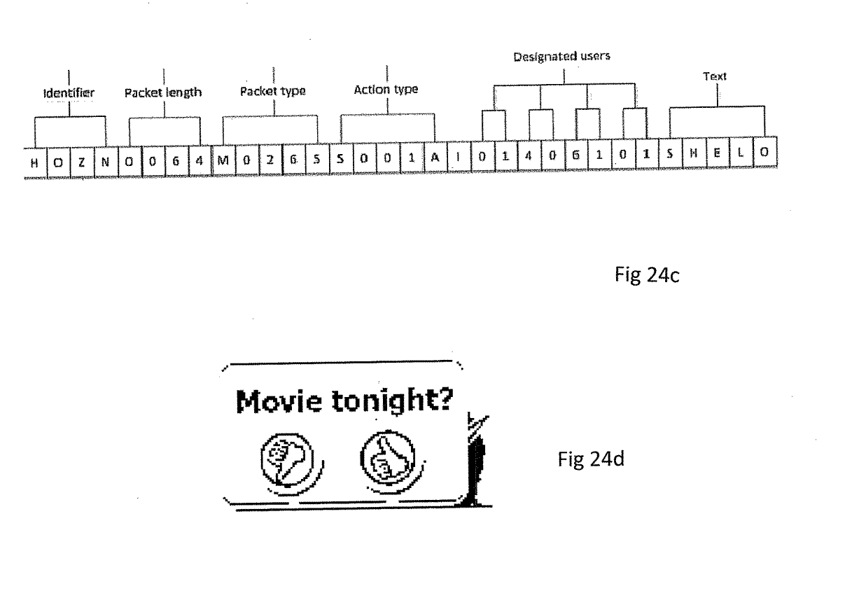

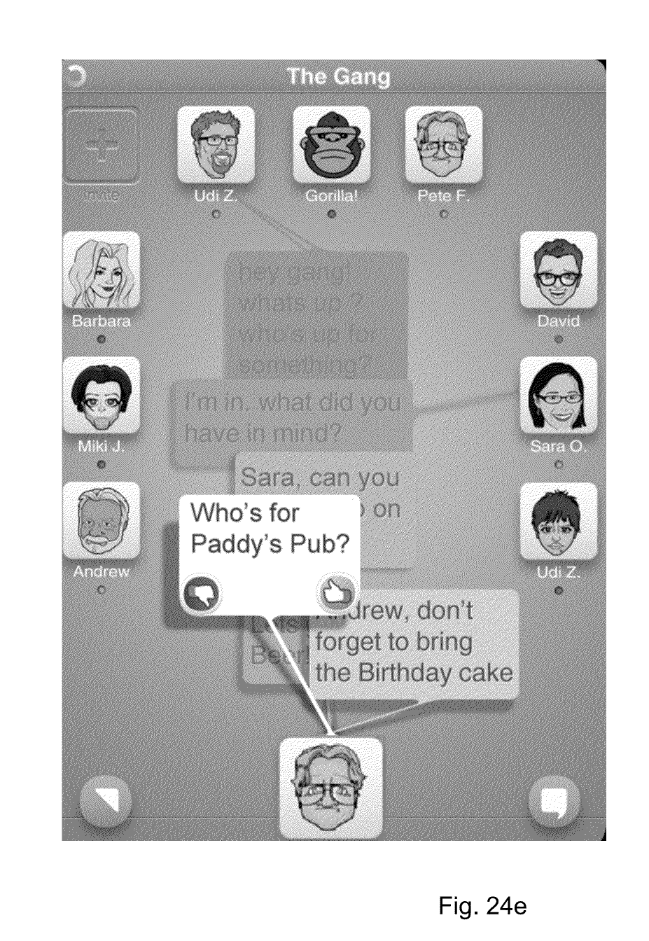

The user may select the designated participants by clicking on their avatar in the conversation room. A menu may then open from which the user may chose an action, as shown in FIG. 24a.

In FIG. 24a, the user (at the bottom of the screen), selects Yuri as the designated participant for receiving the message, then (A. “selected participants saved in temp variable”) the data for this selection is saved and a menu is opened for the user to select from. The menu may be in any type and may be open before the selection of the designated participants or after or may be optional over the keyboard e.g. as illustrated in FIG. 24b which is an example of a keyboard.

After the menu is shown, the user may select the “direct message” action towards the participants that he has selected (Yuri in this Fig. B). When the user selects the “direct message” option, the metadata for this action and for the designated participants is saved (in temp variable) and the keyboard may appear e.g. as shown in FIG. 24b.

When the keyboard is shown, the user may initiate other types of messages (e.g. picture, “emotipicture”) by pressing on a button in the keyboard; any type of message that the user may choose may be “directed message” e.g as described below.

Then the user may write the message (or take a picture etc. . . . ) and send it. Once the user sends the message, the sync message along with the metadata (“MSG_BROADCAST_CHAT_MSG_TO_FRIENDS 65” by the suggested protocol) and the data of the message is sent to the server. The data of this packet may contain (along with the text or picture) all the designated users' IDs.

The server receives the message and the metadata, analyzes it and operates accordingly. In this case of “direct message” the server “understands” by the metadata which of the users in the conversation may get the special notification, and sends them the message with the special notification (flag bit in the data packet), the users that were not designated to get the “direct message” may receive the message without the special notification (may receive the packet with the flag bit of 0).

Packet of “directed message” may for example be as shown in FIG. 24c (MSG_BROADCAST_CHAT_MSG_TO_FRIENDS 65). FIG. 24c exemplifies indication of a “direct message”. The indication is visual—the black message is the “directed message” and the designated participants that the message directed to them are the ones with the black “!” badge on their icon.

Other indications such as the “direct message” may be similar to the example in FIG. 24d above.

Such indications may comprise indications of who received the message, quick poll answers, emoticons etc.

An example flow of a quick poll message is now described.

As based on the flow in FIG. 18, a user may select a type of action (with or without selecting participants). Another example of type of action is a quick poll. A quick poll action is an action (which may be text, picture etc. . . . ) wherein, in the message box, two or more buttons appear. This feature enables each one of the users to initiate a poll during the conversation. The main purpose of this feature is to enable the users to get quick answers from all the other participants. The novelty of this feature when conducted in this invention is that everyone may see the answers of the quick poll within the flow of the conversation, and the indication of who voted, which always appears on the avatars.

As shown in FIG. 18, when the user chooses the type of action, he may choose and initiate a quick poll type of action. When the action “quick poll message” is sent (sync message along with the metadata and data according to the protocol—Packet MSG_BROADCAST_CHAT_MSG_TO_FRIENDS 65 with the type of poll) the action arrives to the server, as in the “direct message” feature, the server analyzes the data and sends the quick poll message to all designated participants (or to everyone in the conversation) and each user may see the quick poll message on the screen and click on the quick poll message's buttons.

FIG. 24d shows an example of a quick poll message icon. The users may press the “yes/no” buttons and this data may appear on the screen.

Poll Participating:

After the quick poll appears on each designated user's screen, the designated user may press on any of the quick poll buttons.

When a user presses on a quick poll button, it sends an action in the same way as in FIG. 24c. A “Sync message is first sent to the server along with the action”. This means that the press on the button is an action that is known by the protocol (Packet MSG_BROADCAST_CHAT_MSG_TO_FRIENDS 65 from type “poll answer”) and has a table in the data base. The database structure typically allows buttons to be conveniently added to the quick poll message (e.g. by adding a table to the database). Each button is another action which contains the data needed. As in the flow, the server sends the answers (actions) to the clients in the room and the client knows how to interpret the action and show an indication of the quick poll answer over the user that sent the action.

FIG. 24e shows an example of quick poll. The poll that says “who's for paddy's pub” is conducted within the flow of the conversation. FIG. 24e shows a conversation after the participants selected one of the buttons. The results then appear on their avatars. The packet metadata of the quick poll may be similar to the “direct message” metadata but with different data.

### Example of “Emotipicture Flow”:

As in the “direct message” and as shown in FIG. 18, the flow is the same until the point of the user completes the action, in this part the user may press on another button that may allow him to take a picture before he sends the message. Once he takes his picture, the data may be sent to the server and when the server broadcasts the message to the participants, the picture data may be sent along with the text message. The picture may appear as the avatar picture of the sender—every time the message with the “emotipicture” is the top most message, the avatar picture of the sender may be changed to the “emotipicture”.

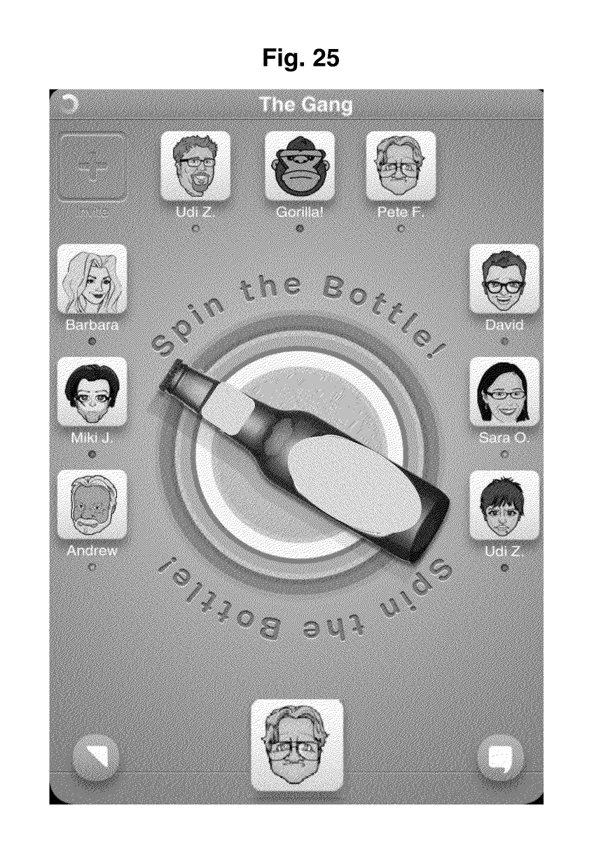

FIG. 25 is an example screenshot showing that a game may be played within a chat session, and a display may be provided to the chat participants, including avatars typically arranged around the periphery of the display, and a game state icon typically located in the center of the display which indicates a state of the game. The state of the game may include, inter alia, e.g. a pointer (such as the top of a bottle in a “spin the bottle” game icon as shown) to one or more participants whose turn it currently is. The avatars may be differentially marked e.g. colored to indicate participants' individual game state e.g. which participants are playing and/or who is “up to bat” and/or each participant's score or special game status.

Actions may be directed to all participants of one virtual chat room or only to a sub-group of participants in the room. Furthermore there may be several types of actions such as but not limited to: message, direct, secret, quick poll. Every type of action may be signified by special graphic indication that may appear over the message, the avatar or both simultaneously. The data may be saved per room, action and type of action, using metadata to make any necessary distinctions. So typically, it is possible to “filter” a display—display only part of the data in a room; responsive to a user request the system may display, for example, just the “direct messages” conducted in a room or just the quick poll messages or to display just messages that came from a specific user.

Typically, the user indicates that s/he would like to “filter” messages. The indication may for example be by special gesture, for instance—if the user wants to see all the messages from a specific participant, he may “drag and drop” his avatar to the center and that may be the indication responsive to which the messages from this avatar are displayed. Then the client typically “flags” all the messages that are filtered and shows only the messages that the user wished to see.

If desired, users may be entitled to set modes of notification. In the “direct message” feature a user controls who is to receive notification and who is to see the message but without receiving special notification. In the same way one may decide not to get notification from a specific user (“silent”) or to give special notification to another. For instance, the user may press on an avatar and choose to “silence” him.

Metadata may be provided as suitable, and attached e.g. to messages, avatars or other elements of the application, to implement any of the embodiments shown and described herein. For example, one metadatum may indicate whether a particular message is private, direct or a regular message, typically intended for “broadcast”. This metadatum may be provided, for example, in the action type string of FIGS. 20a-20e. for example, “direct message” may be encoded as 001A, “private message” as 001B, “quick poll” may be encoded as 001C, and so forth.

It is appreciated that any suitable combination of the features shown and described herein is included in the scope of the invention, including but not limited to any or all of the following features and sub-features, alone or in any suitable combination:

1. Time (sequence of messages e.g.) is shown along a “virtual” Z axis (depth), as opposed to existing mobile and non-mobile chat solutions where the message sequence axis is Y, generating a list of messages along the screen, from top to bottom, representing sequence. typically, the most recent message is always on top of the “pile” and older messages are below, and fade away into the background using suitable visual effects such as but not limited to:
1a. The text (or other content) of the message, as it is superseded by other messages, becomes gradually transparent
1b. The background color of the message gradually becomes similar to the background color
1c. Concealment in order (a newer message may partially hide older ones (sometimes)
1d. Gradually changing shadow effect of the message bubble (icon)
   2. Message placement method which takes into account the size of the screen (especially in mobile applications with their small screens) and places the messages on screen, based on at least one of:
2a. Ability to place as much readable text on screen as possible, typically including allowing user to read a few messages back in history on a single still frame. Attempt to avoid messages piling over each other in a way that entirely hides past messages.
2b. Appearance—Placing messages in a way which is “easy on the eyes”, and gives a natural feeling to the conversation, e.g. based on one or more of:
   i. not too far from the sender's avatar
   ii. place near older messages
   iii. height and width of message bubble is easy to use and appropriate to message (e.g. length and possibly content)
      3. Logical/graphical connection between specific messages and different indicator on avatars—typically including placing/showing an indication that is related to a specific message, and that appears adjacent and/or with reference or association to the specific message. Typically, the pile of messages is dynamic such that a user may “draw” a message off the pile or stack (thereby to go back in history) or put messages back on the pile or stack (go forward in history). Indications that may appear with regard to e.g. the top-most messages may include some or all of:
3a. Indication of the sender
3b. Indication of addressees e.g. in special messages such as private messages and direct messages
3c. Indication of who received and/or read a specific message (also termed herein a “rx/read ACK” indication)
3d. poll answers
3e. Emoticons that refer to e.g. are associated with a specific message
3f. “Emotipicture”—a change in the avatar's picture that is associated by the user to a specific message—e.g. take a picture of a facial expression with regard to a message
   4. Chat participants may control Dynamics of the conversation flow e.g. including selectably performing any or all of:
4a. Direct an operation e.g. send message, toward a sub-group of the chat participants, e.g. by clicking on their avatars, while remaining within the group domain.
4b. The ability to execute an operation (e.g. send a message, propose to play a game) toward a single participant e.g. by clicking on his avatar, while remaining within the group domain.
4c. The ability to conduct several sub-group discussions (each of which may selectably be, say, directed or private) in one group domain. The composition and the size of the sub-groups may change all the time.
   5. Filtering—Due to the variation in addressees within the group, many filtering options are enabled. such as the filtering described hereinabove.
   6. Notification settings—Due to changing message types (addressed to me or not, sender identity, direct or private), one may set notifications by logically combining any available message metadata including message types, e.g. give me notification only of messages addressed to me, and/or only if such messages are direct/private. and/or only if the sender is x, or is not y, and/or only in the afternoon.

6a. for example: Ability to mute specific chat member with one click—and then not get notification of messages from her or him.

7. Direct message—sender may click on avatars to indicate that a message is only for a subset, termed addressees, of chat partipicants. Typically, this message is sent to all participants, but, by default, non-addressee recipients do not get notified (when they are outside the app i.e. outside the chatroom and may not see a special graphic indication, on the message, of receipt of a direct message within a group s/he belongs to, if s/he is not a specific addressee.
7a. The sender of the direct message may send the message after he indicates who the message is to be directed to.
7b. The addressees get the message and notification.
7c. All other participants may see the message but do not get notification.
   8. Protocol parameters:
8a. Message types—may be all sorts of actions e.g. games, polls, links, visual materials, which are not necessarily texts or even visible
8b. Indications and ACK—for each action (e.g. message) there is a field of updated indication that may dynamically change, and enables the change of an indication that refers to a specific action (message)
8c. Other than the room information, an action may carry a list of addressees.
   9. Scrolling through history:

9a. various indications re a message becomes visible when scrolling through history and arriving at that message

9b. indications may, dynamically and retroactively, be changed (such as read message ACK).

It is appreciated that terminology such as “mandatory”, “required”, “need” and “must” refer to implementation choices made within the context of a particular implementation or application described herewithin for clarity and are not intended to be limiting since in an alternative implantation, the same elements might be defined as not mandatory and not required or might even be eliminated altogether.

It is appreciated that software components of the present invention including programs and data may, if desired, be implemented in ROM (read only memory) form including CD-ROMs, EPROMs and EEPROMs, or may be stored in any other suitable typically non-transitory computer-readable medium such as but not limited to disks of various kinds, cards of various kinds and RAMs. Components described herein as software may, alternatively, be implemented wholly or partly in hardware, if desired, using conventional techniques. Conversely, components described herein as hardware may, alternatively, be implemented wholly or partly in software, if desired, using conventional techniques.

Included in the scope of the present invention, inter alia, are electromagnetic signals carrying computer-readable instructions for performing any or all of the steps of any of the methods shown and described herein, in any suitable order; machine-readable instructions for performing any or all of the steps of any of the methods shown and described herein, in any suitable order; program storage devices readable by machine, tangibly embodying a program of instructions executable by the machine to perform any or all of the steps of any of the methods shown and described herein, in any suitable order; a computer program product comprising a computer useable medium having computer readable program code, such as executable code, having embodied therein, and/or including computer readable program code for performing, any or all of the steps of any of the methods shown and described herein, in any suitable order; any technical effects brought about by any or all of the steps of any of the methods shown and described herein, when performed in any suitable order; any suitable apparatus or device or combination of such, programmed to perform, alone or in combination, any or all of the steps of any of the methods shown and described herein, in any suitable order; electronic devices each including a processor and a cooperating input device and/or output device and operative to perform in software any steps shown and described herein; information storage devices or physical records, such as disks or hard drives, causing a computer or other device to be configured so as to carry out any or all of the steps of any of the methods shown and described herein, in any suitable order; a program pre-stored e.g. in memory or on an information network such as the Internet, before or after being downloaded, which embodies any or all of the steps of any of the methods shown and described herein, in any suitable order, and the method of uploading or downloading such, and a system including server/s and/or client/s for using such; and hardware which performs any or all of the steps of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any step described herein may be computer-implemented. The invention shown and described herein may include (a) using a computerized method to identify a solution to any of the problems or for any of the objectives described herein, the solution optionally includes at least one of a decision, an action, a product, a service or any other information described herein that impacts, in a positive manner, a problem or objectives described herein; and (b) outputting the solution.

The scope of the present invention is not limited to structures and functions specifically described herein and is also intended to include devices which have the capacity to yield a structure, or perform a function, described herein, such that even though users of the device may not use the capacity, they are, if they so desire, able to modify the device to obtain the structure or function.

Features of the present invention which are described in the context of separate embodiments may also be provided in combination in a single embodiment.

For example, a system embodiment is intended to include a corresponding process embodiment. Also, each system embodiment is intended to include a server-centered “view” or client centered “view”, or “view” from any other node of the system, of the entire functionality of the system, computer-readable medium, apparatus, including only those functionalities performed at that server or client or node.

Conversely, features of the invention, including method steps, which are described for brevity in the context of a single embodiment or in a certain order may be provided separately or in any suitable subcombination or in a different order. “e.g.” is used herein in the sense of a specific example which is not intended to be limiting. Devices, apparatus or systems shown coupled in any of the drawings may in fact be integrated into a single platform in certain embodiments or may be coupled via any appropriate wired or wireless coupling such as but not limited to optical fiber, Ethernet, Wireless LAN, HomePNA, power line communication, cell phone, PDA, Blackberry GPRS, Satellite including GPS, or other mobile delivery. It is appreciated that in the description and drawings shown and described herein, functionalities described or illustrated as systems and sub-units thereof can also be provided as methods and steps therewithin, and functionalities described or illustrated as methods and steps therewithin can also be provided as systems and sub-units thereof. The scale used to illustrate various elements in the drawings is merely exemplary and/or appropriate for clarity of presentation and is not intended to be limiting.

Aside from what is specifically claimed and described herein, a method corresponding to any of the claims, and a computer program product, comprising a non-transitory computer usable medium having a computer readable program code embodied therein, said computer readable program code adapted to be executed to implement any of the methods herein, are each included in the scope of the present invention.

1. A system for conducting chat sessions on a screen, the system comprising:
apparatus for displaying, on a screen, a plurality of stationary avatars respectively representing a plurality of chat participants over time; and
apparatus for displaying, on the screen, a temporal sequence of chat events including a processor operative to utilize stored metadata characterizing each event's position in the temporal sequence and each event's logical association with a respective one of the plurality of avatars to generate a visual representation of the temporal sequence in which both of the following are visually represented simultaneously:
each event's position in the temporal sequence; and
at least one logical association between each event and a respective one of the plurality of avatars.

2. A system for conducting chat sessions on a screen, the system comprising:
apparatus for displaying a temporal sequence of messages including simultaneously displaying a plurality of message icons representing a corresponding plurality of messages including older messages and newer messages wherein the apparatus for displaying includes a processor determining positioning for message icons such that the older messages' icons visually appear to be deeper than the newer messages' icons, thereby to enhance a viewer's perception of the temporal characteristics of the sequence.

3. A system according to claim 2 wherein the older messages' icons are more transparent than the newer messages' icons, thereby to achieve a viewer experience wherein the older messages' icons visually appear to be deeper than the newer messages' icons.

4. A system according to claim 2 wherein the temporal sequence of messages is presented on a background having a color and wherein the older messages' icons are more similar to said color than are the newer messages' icons, thereby to achieve a viewer experience wherein the older messages' icons visually appear to be deeper than the newer messages' icons.

5. A system according to claim 3 wherein the older messages' icons are partially occluded by the newer messages' icons, thereby to achieve a viewer experience wherein the older messages' icons visually appear to be deeper than the newer messages' icons.

6. A system according to claim 2 wherein the icons are shadowed such that older messages' icons are less heavily shadowed than the newer messages' icons, thereby to achieve a viewer experience wherein the older messages' icons visually appear to be deeper than the newer messages' icons.

7. A system for conducting chat sessions, for serving a client having:
a first mode of client operation in which an individual client is inside a chatroom environment in which an ongoing chat session is being held; and
a second mode of client operation in which an individual client belongs to the ongoing chat session but is not in the chatroom,
the system comprising:
apparatus for receiving and storing in computer storage, metadata indicating notification options for individual messages; and
selective chat message notification apparatus operative, based on said meta-data, to provide to a client in the second mode a push notification (or any other kind of notification) that a message has been contributed to the ongoing chat session by a contributing client, but only selectably, depending at least in part on a selection made by the individual client and reflected in said metadata.

8. A system for conducting chat sessions on a screen, the system comprising:
apparatus for generating a display of a group of avatars arranged around a periphery of a screen; and
a location determination apparatus operative to perform location determination for determining a location at which to display a sequence of messages exchanged between a group of communicators represented by the group of avatars, wherein said location determination comprises:
using message metadata to identify a plurality of messages which is logically associated with an individual avatar; and
generating a virtual stack of message icons which visually appears to be associated with the individual avatar.

9. A system according to claim 8 wherein the stack is more adjacent to the individual avatar than to other avatars thereby to cause the stack to visually appear to be associated with the individual avatar.

10. A system according to claim 8 wherein said location determination further includes using a processor for accessing a stored logical association of the individual avatar with at least one individual message and accessing a stored location of the individual avatar and generating a display in which a message icon in the stack, representing said individual message, is visually connected to the individual avatar thereby to cause the stack to visually appear to be associated with the individual avatar.

11. A system according to claim 8 wherein the message icons are stationary on the screen.

12. A system according to claim 8 wherein an oldest message icon in the stack is deleted from the screen once a maximum number of newer message icons in the stack have been received and are displayed on the screen.

13. A system according to claim 8 wherein a bi-directional user-controlled stack scrolling functionality is provided and wherein, when the stack scrolling functionality is operated in a first, new to old, direction, a newest message icon in the stack is deleted from the screen and a most recently deleted old message icon is restored to the screen, whereas when the stack scrolling functionality is operated in a second, old to new, direction, a newest message icon in the stack is restored to the screen and a most recently restored old message icon is deleted from the screen.

14. A system according to claim 8 wherein the stack scrolling functionality is actuated by a swipe.

15. A system according to claim 8 wherein the stack scrolling functionality is actuated by a virtual button.

16. A system for conducting chat sessions on a screen, the system comprising:
apparatus for generating a display of a group of avatars arranged around a periphery of a screen;
apparatus for generating and storing metadata representing a user's selection of a selected avatar from among the group of avatars, and for using said metadata for effecting a user-requested operation on the selected avatar and not for other avatars from among the group of avatars; and
apparatus for displaying messages exchanged between a group of communicators represented by the group of avatars to the user even while the user is performing the operation on the selected one of the group of avatars.

17. A system according to claim 16 wherein said apparatus for allowing a user to perform an operation on a selected one of the group of avatars provides a one-click functionality for selecting said selected avatar.

18. A system according to claim 8 wherein differently located portions of different message icons are occluded by respectively temporally adjacent message icons, rather than identically located portions of different message icons being occluded, thereby to allow the message icons in the stack to remain more adjacent to the individual avatar, than the message icons would be if identically located portions of different message icons were occluded.

19. A system for conducting chat sessions on a screen, the system comprising:
apparatus for generating a display of a group of avatars on a screen; and
metadata handling apparatus for storing metadata regarding the avatars, retrieving and displaying the metadata to a chat participant during a chat, and receiving a metadata update from a chat participant during a chat participant and updating the metadata accordingly.

20. A system according to claim 19 wherein the metadata is specific to at least one individual message sent within the chat and wherein said metadata handling apparatus is operative to display metadata specific to the individual message responsive to a chat participant's selecting an individual message.

21. A system according to claim 20 wherein metadata regarding a message is stored even after the message is no longer visible on the screen and wherein the system also comprises message display apparatus which deletes old messages from the screen and identifies a chat participant's scrolling back operation in which the participant scrolls back to an individual message no longer visible on the screen and responsively, restores the individual message, thereby to allow the individual message to be selected by the user, responsive to which the metadata handling apparatus retrieves and displays metadata specific to the individual message.

22. A system according to claim 19 wherein the metadata comprise at least one of:
an acknowledgement that a chat participant has received a chat message sent to her/him;
an acknowledgement that a chat participant has read a chat message sent to her/him; and
an indication of an emoticon associated by a chat participant with a message sent by her or him;
An indication of a poll answer associated by a chat participant with a message sent to or by him;
An indication of a form of a changed Avatar illustration associated by a chat participant with a message sent to or by him; and
An indication of a participant's geographical location associated by a chat participant with a message sent to or by him.

23. A system according to claim 18 wherein the plurality of messages is visually represented as a stack of message icons.

24. A system according to claim 8 wherein at least one message icon includes text.

25. A system according to claim 1 wherein the screen comprises one of: a mobile communication device screen, a cellular telephone screen, a smartphone screen.

26. A system according to claim 8 wherein said location determination also comprises determining a message icon location for each of several pairs of first and second temporally adjacent message icons in the stack, such that the first icon occludes the second icon, but only partially, such that at least a portion of the content included in the second icon is visible despite the first icon.

27. A system according to claim 8 wherein a plurality of messages which is logically associated with an individual avatar is visually represented as a stack, which visually appears to be associated with the individual avatar, of message icons, and wherein, for each of several pairs of first and second temporally adjacent message icons in the stack, the first icon occludes the second icon, but only partially, such that at least a portion of the content included in the second icon is visible despite the first icon.

28. A system according to claim 7 wherein said selective chat message notification apparatus is operative, based on said meta-data, to provide said push notification also depending at least in part on a selection made by the contributing client.

29. A system according to claim 1 wherein each event's position in the temporal sequence is represented as a virtual depth along a virtual z-axis perpendicular to the screen and wherein at least one logical association between each event and a respective one of the plurality of avatars is represented as a property within the x-y plane of the screen.

30. A system according to claim 29 wherein, for at least one logical association, said property within the x-y plane of the screen comprises adjacency within the x-y plane between each event and a respective one of the plurality of avatars which has at least one logical association therewith.

31. A system according to claim 1 wherein at least one message is represented by a message icon which remains stationary on the screen until deleted.

32. A system according to claim 1 wherein the chat events include at least one message from one chat participant to at least one other chat participant.

33. A system according to claim 1 wherein the chat events include at least one game.

34. A system according to claim 1 wherein the chat events include at least one poll.

35. A system according to claim 1 wherein the avatars are arranged around the screen's periphery.

36. A system according to claim 32 and wherein said logical association comprises a sender association whereby a message is associated with an avatar because the message was sent by a chat participant represented by the avatar.

37. A system according to claim 32 and wherein said logical association comprises a recipient association whereby a message is associated with an avatar because the message was received by a chat participant represented by the avatar.

38. A system according to claim 37 wherein said recipient association is represented by an avatar property e.g. color, graphical connection, animation, badge.

39. A system according to claim 34 and wherein said logical association represents a particular response status of a participant corresponding to the avatar, within the poll.

40. A system according to claim 33 wherein said logical association represents a state, within the game, of a participant corresponding to the avatar.

41. A system according to claim 1 wherein said apparatus for displaying, on a screen, a plurality of stationary avatars is operative to visually display at least one property of an individual chat participant by modifying at least one characteristic of the avatar from among the plurality of stationary avatars which corresponds to the individual chat participant.

42. A system according to claim 41 wherein said characteristic comprises a color.

43. A system according to claim 41 wherein said characteristic comprises a visual characteristic other than color.

44. A system according to claim 1 wherein a message icon is deleted from a chat display when superseded by a predetermined number of messages issued by participants in the chat, such as but not limited to 3, 5, 7, 10 or any other suitable number of messages.

45. A system according to claim 39 wherein said response status indicates that the participant did/did not participate in the poll.

46. A system according to claim 39 wherein said response status indicates that the participant selected a particular response within the poll.

47. A system according to claim 40 wherein said state indicates at least one of the following:
said participant is/is not participating in the game,
it is/is not currently this participant's turn;
said participant's score;
said participant's team association if the game is a team game.

48. A system according to claim 29 wherein each individual event's position in the temporal sequence is represented by adjacency of an event icon representing the individual event, to other event icons which represent other events which are temporally adjacent to the individual event.

49. A system according to claim 1 wherein the system also comprises apparatus for accepting subgroups defined by a chat participant within a chat session by selecting a subset of individual avatars from among said stationary avatars.

50. A system according to claim 1 wherein each message logically associated to a specific avatar, subject to at least one constraint including lack of free space, is positioned as close as possible to a line extending from the screen center to the specific avatar.

51. A system according to claim 1 wherein subject to at least one constraint including lack of free space, each message is positioned as close as possible to the center of the screen's message area such that messages are perceived to extend from the center of the message area towards the avatar.

52. A system according to claim 1 wherein for at least one message icon dimension such as width or length, the dimension is within predetermined bounds and wherein, subject to at least one constraint including lack of free space, the dimension is as close as possible to a predefined ideal size for that dimension.

53. A system according to claim 49 wherein said apparatus for accepting subgroups is operative to cause a message defined by a chat participant as “direct”, to be visible as a message icon to all chat participants but to trigger an outside/inside-chat-application notification only to chat participants outside and inside the chat application which belong to a subgroup defined by the chat participant and associated with said message defined by the chat participant as “direct”.

54. A system according to claim 49 wherein said apparatus for accepting subgroups is operative to cause a message defined by a chat participant as “private”, to be visible as a message icon, and to trigger an outside-chat-application notification, only to chat participants outside the chat application which belong to a subgroup defined by the chat participant as associated with said message defined by the chat participant as “private”.

55. A system according to claim 4 wherein the older messages' icons are partially occluded by the newer messages' icons, thereby to achieve a viewer experience wherein the older messages' icons visually appear to be deeper than the newer messages' icons.

56. A system according to claim 26 wherein a portion of the message icon representation such as a square/bubble illustration included in the second icon is visible despite the first icon.

57. A system according to claim 1 wherein chat events such as messages are placed so as to optimize the number of events visible on a single still frame.

58. A system according to claim 57 wherein chat events including text are placed so as to optimize the number of chat events visible and at least partly readable on a single still frame.

59. A system according to claim 6 wherein icons vary along at least one of the following dimensions: size of offset, color intensity, size.

60. A system according to claim 27 wherein a portion of the message icon representation such as a square/bubble illustration included in the second icon is visible despite the first icon.
